(19) United States
(12) Patent Application Publication
(10) Pub. No.: US 2026/0016767 A1
(43) Pub. Date: Jan. 15, 2026

(54) IMAGE FORMING APPARATUS

(71) Applicant: CANON KABUSHIKI KAISHA, Tokyo (JP)

(72) Inventor: TSUKASA ABE, Kanagawa (JP)

(21) Appl. No.: 19/258,674

(22) Filed: Jul. 2, 2025

(30) Foreign Application Priority Data
Jul. 10, 2024 (JP) 2024-111320

(51) Int. Cl. G03G 15/01; G03G 15/08; G03G 21/16

(52) U.S. Cl. CPC G03G 15/0121; G03G 15/0189; G03G 15/0865; G03G 21/1619; G03G 21/1633; G03G 21/1647; G03G 21/1652

(57) ABSTRACT

An image forming apparatus includes a housing, a tray configured to be withdrawn toward a first direction from a state where the tray is inserted in the housing, a cartridge configured to be separated from the tray in a second direction, and a movable member including a restriction portion, the movable member being configured to move between a first position and a second position in a third direction, wherein, in a state where the tray is inserted in the housing and the movable member is at the first position, the restriction portion overlaps the cartridge when viewed in the second direction, whereas in a state where the tray is inserted in the housing and the movable member is at the second position, the restriction portion does not overlap the cartridge when viewed in the second direction.

### BACKGROUND

### Field of the Technology

The present disclosure relates to an image forming apparatus configured to form an image on a recording medium.

### Description of the Related Art

Japanese Patent Application Laid-Open No. 2014-106392 discusses an image forming apparatus in which a cartridge can be attached to and detached from a tray configured to be inserted into and withdrawn from a main body of the image forming apparatus.

In a configuration in which a cartridge is attached to a tray configure to be inserted into and withdrawn from a main body of an apparatus, it is desirable to restrict cartridge misregistration in a direction of being separated from the tray due to the impact of a fall. On the other hand, it is also desirable to avoid a situation where the operability of the tray is affected, such as hindrance to tray movement caused by the configuration for restricting cartridge misregistration.

### SUMMARY

The present disclosure is directed to providing an image forming apparatus capable of restricting cartridge misregistration without affecting the operability of a tray.

According to some embodiments, an image forming apparatus includes a housing, a tray inserted in the housing, the tray being configured to be withdrawn toward a first direction from a state where the tray is inserted in the housing, a cartridge attached to the tray, the cartridge being configured to be separated from the tray in a second direction intersecting the first direction in a state where the tray is withdrawn from the housing, and a movable member supported by the housing and including a restriction portion, the movable member being configured to be restricted from moving in the second direction and being configured to move between a first position and a second position in a third direction intersecting both the first direction and the second direction, wherein, in a state where the tray is inserted in the housing and the movable member is at the first position, the restriction portion overlaps the cartridge when viewed in the second direction, and the restriction portion restricts movement of the cartridge in the second direction relative to the tray, whereas in a state where the tray is inserted in the housing and the movable member is at the second position, the restriction portion does not overlap the cartridge when viewed in the second direction, and wherein, in a case where the movable member is at the second position, the restriction portion is retracted from a movement trajectory of the tray and the cartridge, where the movement trajectory of the tray and the cartridge is a space through which the tray and the cartridge pass during withdrawal of the cartridge and the tray from the housing.

Features of the present disclosure will become apparent from the following description of embodiments with reference to the attached drawings. The following description of embodiments are described by way of example.

### BRIEF DESCRIPTION OF THE DRAWINGS

FIG. 1 is an outline view illustrating a printer according to a first exemplary embodiment.

FIG. 2 is an illustrative view illustrating the printer according to the first exemplary embodiment.

FIG. 3 is an illustrative view illustrating the printer according to the first exemplary embodiment.

FIG. 4 is an illustrative view illustrating the printer according to the first exemplary embodiment.

FIG. 5 is an illustrative view illustrating the printer according to the first exemplary embodiment.

FIG. 6 is an illustrative view illustrating the printer according to the first exemplary embodiment.

FIG. 7 is an illustrative view illustrating the printer according to the first exemplary embodiment.

FIGS. 8A to 8F are illustrative views illustrating a movable member and a link mechanism according to the first exemplary embodiment.

FIG. 9 is an illustrative view illustrating a main body of the printer according to the first exemplary embodiment.

FIG. 10 is an illustrative view illustrating a main body of the printer according to the first exemplary embodiment.

FIG. 11A is a diagram illustrating a state where a door of the printer according to the first exemplary embodiment is closed, and FIG. 11B is a cross-sectional view along line A-A′ in FIG. 11A.

FIG. 12A illustrates a state where the door of the printer according to the first exemplary embodiment is opened, and FIG. 12B is a cross-sectional view along line A-A′ in FIG. 12A.

FIG. 13A illustrates a state during withdrawal of a tray unit from the main body of the printer according to the first exemplary embodiment, and FIG. 13B is a cross-sectional view along line A-A′ in FIG. 13A.

FIG. 14 is an assembly view illustrating a left side plate and a holder according to the first exemplary embodiment, with an enlarged view illustrating a portion of the holder.

FIG. 15A illustrates a state where a door of a printer according to a second exemplary embodiment is closed, and FIG. 15B is a cross-sectional view along line A-A′ in FIG. 15A.

FIG. 16 is an assembly view illustrating a left side plate and a holder according to the second exemplary embodiment, with an enlarged view illustrating a portion of the left side plate.

FIG. 17 is a cross-sectional view illustrating an example of a cartridge.

FIG. 18 is an exploded view illustrating a drum unit related to an example of a cartridge.

FIG. 19 is an exploded view illustrating a development unit related to an example of a cartridge.

FIG. 20 is an assembly view related to an example of a cartridge.

FIG. 21 is a perspective view illustrating an example of a cartridge.

FIG. 22 is a schematic view illustrating a remaining toner quantity detection mechanism related to an example of a cartridge.

FIG. 23 is a perspective view illustrating a non-drive-side end portion of an example of a cartridge.

FIG. 24 is a side view illustrating a non-drive-side end portion of an example of a cartridge.

### DESCRIPTION OF THE EMBODIMENTS

Various exemplary embodiments, features, and aspects of the present disclosure will be described with reference to the drawings.

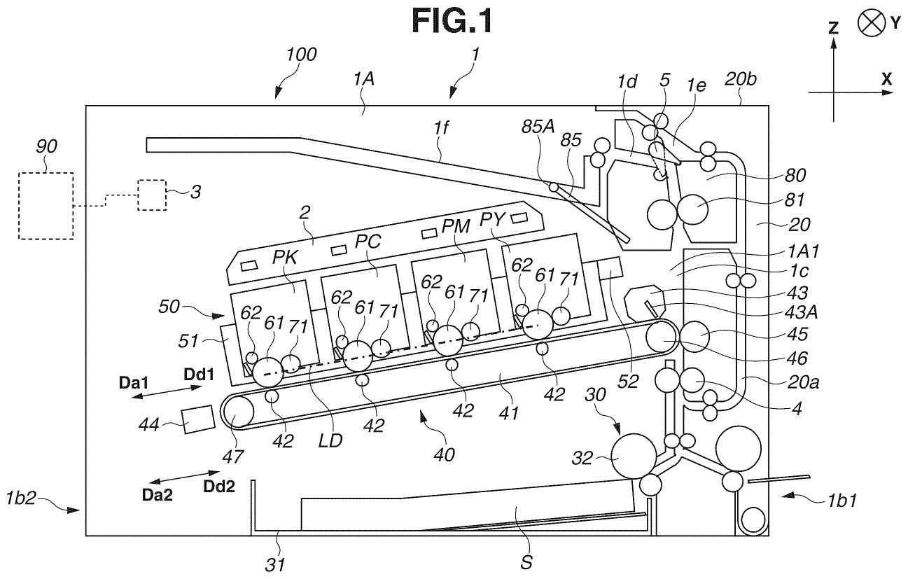

A printer 1 as an image forming apparatus according to an exemplary embodiment (first exemplary embodiment) will be described with reference to FIG. 1. FIG. 1 is an outline view illustrating an overall configuration of the printer 1 according to the present exemplary embodiment. The printer 1 is an electrophotographic color laser beam printer configured to form an image on a sheet S as a recording medium.

In the following description and drawings, a Z-axis direction refers to a vertical direction in a case where the printer 1 is placed on a horizontal surface. A Y-axis direction refers to a rotational axis direction of a photosensitive drum 61 of the printer 1. An X-axis direction refers to a direction intersecting both the Z- and Y-axis directions. The X-, Y-, and Z-axis directions are desirably orthogonal to one another. Further, one side (the side indicated by an arrow of X) in the X-axis direction may be referred to as the +X side or +X direction whereas the other side in the X-axis direction may be referred to as the −X side or −X direction. Similarly, one side (the side indicated by an arrow of Y) in the Y-axis direction may be referred to as the +Y side or +Y direction whereas the other side in the Y-axis direction may be referred to as the −Y side or −Y direction, and one side (the side indicated by an arrow of Z) in the Z-axis direction may be referred to as the +Z side or +Z direction whereas the other side in the Z-axis direction may be referred to as the −Z side or −Z direction.

The +X direction may also be referred to as the front side (front-facing side) of the printer 1. Further, with the printer 1 viewed from the front side as a reference, the +Y side may be referred to as the right side and the −Y side as the left side.

As illustrated in FIG. 1, the printer 1 includes an apparatus main body 1A (housing), a scanner 2 as an exposure device, a control unit 3, and a door 20 as an opening and closing member. Further, the printer 1 includes a sheet feed unit 30, a transfer unit 40, a tray unit (moving unit) 50, and a fixing device 80. The portion that includes the apparatus main body 1A and the door 20 may also be referred to as a main frame 100 of the printer 1. The main frame 100 includes an exterior portion of the printer 1.

The apparatus main body 1A houses the scanner 2, the control unit 3, the sheet feed unit 30, the transfer unit 40, secondary transfer roller 45, the tray unit 50, and the fixing device 80.

The sheet feed unit 30 includes a loading tray 31 (cassette) configured to load a sheet S used as a recording medium and a feed roller 32 as a feed member configured to feed the sheet S. The loading tray 31 is configured to be withdrawn toward the door 20 to allow replenishment of a sheet S. In the present exemplary embodiment, the direction in which the door 20 is opened and the direction in which the loading tray 31 is withdrawn are the same direction corresponding to the +X side.

The tray unit 50 includes a tray 51 (supporting member, drawer) and cartridges PY, PM, PC, and PK. The tray 51 includes a tray handle 52 (gripping portion). The cartridges PY, PM, PC, and PK are detachably (removably) attached to the tray 51.

The cartridges PY, PM, PC, and PK are independently attachable to and detachable from the tray 51. The cartridges PY, PM, PC, and PK respectively store yellow (Y), magenta (M), cyan (C), and black (K) toner (developer). The cartridges PY, PM, PC, and PK have the same configuration, except that the cartridges PY, PM, PC, and PK store toner of different colors. Thus, the configuration and operation of only one of the cartridges PY, PM, PC, and PK may be described, and descriptions of the others may be omitted. Further, when distinction among the cartridges PY, PM, PC, and PK is unnecessary, the cartridges PY, PM, PC, and PK may be referred to simply as the cartridge P. The tray unit 50 includes the plurality of cartridges P and the tray 51 to which the plurality of cartridges P is removably attached.

In the present exemplary embodiment, the tray unit 50 includes a plurality of photosensitive drums (image bearing member) 61, a plurality of charging rollers 62 (charging member), and a plurality of development rollers (developer bearing member) 71. Specifically, the tray unit 50 includes four photosensitive drums 61, four charging rollers 62, and four development rollers 71. The rotational axis directions of the photosensitive drums 61, the development rollers 71, and the charging rollers 62 are substantially parallel.

A black station (first station) refers to a portion of the tray unit 50 that forms a black image, and the photosensitive drum 61, the development roller 71, and the charging roller 62 of the first station may be referred to as a first photosensitive drum, a first development roller, and a first charging roller, respectively. A cyan station (second station) refers to a portion of the tray unit 50 that forms a cyan image, and the photosensitive drum 61, the development roller 71, and the charging roller 62 of the second station may be referred to as a second photosensitive drum, a second development roller, and a second charging roller, respectively. A magenta station (third station) refers to a portion of the tray unit 50 that forms a magenta image, and the photosensitive drum 61, the development roller 71, and the charging roller 62 of the third station may be referred to as a third photosensitive drum, a third development roller, and a third charging roller, respectively. A yellow station (fourth station) refers to a portion of the tray unit 50 that forms a yellow image, and the photosensitive drum 61, the development roller 71, and the charging roller 62 of the fourth station may be referred to as a fourth photosensitive drum, a fourth development roller, and a fourth charging roller, respectively.

The cartridge PK attached to the tray 51 constitutes at least a portion of the black station. The cartridge PC attached to the tray 51 constitutes at least a portion of the cyan station. The cartridge PM attached to the tray 51 constitutes at least a portion of the magenta station. The cartridge PY attached to the tray 51 constitutes at least a portion of the yellow station. The cartridges PK, PC, PM, and PY may be referred to as first, second, third, and fourth cartridges, respectively.

The ordinals such as first, second, third, and fourth used in the foregoing description are for convenience of explanation only.

The photosensitive drum 61, the charging roller 62, and the development roller 71 may be provided to either the cartridge P or the tray 51. In the present exemplary embodiment, the cartridge P includes the photosensitive drum 61, the charging roller 62, and the development roller 71.

The transfer unit 40 includes a belt 41, primary transfer rollers 42, a cleaning portion 43, a drive roller 46 configured to drive the belt 41, and a tension roller 47. Further, an optical sensor 44 configured to detect a toner image transferred by the belt 41 is disposed in the printer 1. In the present exemplary embodiment, the belt 41 is disposed below the photosensitive drums 61 and configured to be brought into contact with the photosensitive drums 61 to form primary transfer portions between the belt 41 and the photosensitive drums 61.

Further, the printer 1 includes a secondary transfer roller 45 configured to be brought into contact with the belt 41 to form a secondary transfer portion. The secondary transfer portion is formed between the belt 41 and the secondary transfer roller 45. The rotational axis directions of the primary transfer rollers 42, the drive roller 46, the tension roller 47, and the secondary transfer roller 45 are substantially parallel. A pair of registration rollers 4 is disposed upstream of the secondary transfer portion in a conveyance direction of the sheet S.

The fixing device 80 includes a fixing portion 81 and a switching guide 5. In the present exemplary embodiment, the fixing device 80 is configured to move between a use position and a retracted position with respect to the apparatus main body 1A. During an image forming operation, the fixing device 80 is at the use position. The fixing device 80 is housed within (inside) the apparatus main body 1A in a state where the fixing device 80 is at the use position. Further, the fixing device 80 is configured to heat the sheet S in a state where the fixing device 80 is at the use position. The fixing portion 81 includes a heating portion (heating roller) and a pressing portion (pressing roller). The heating portion includes a heater (heat source), and the pressing portion and the heating portion together form a fixing nip.

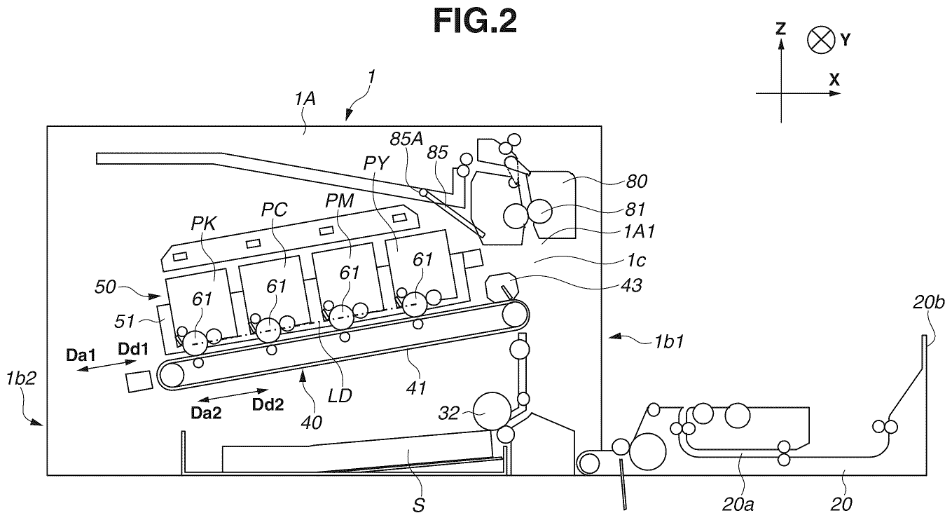

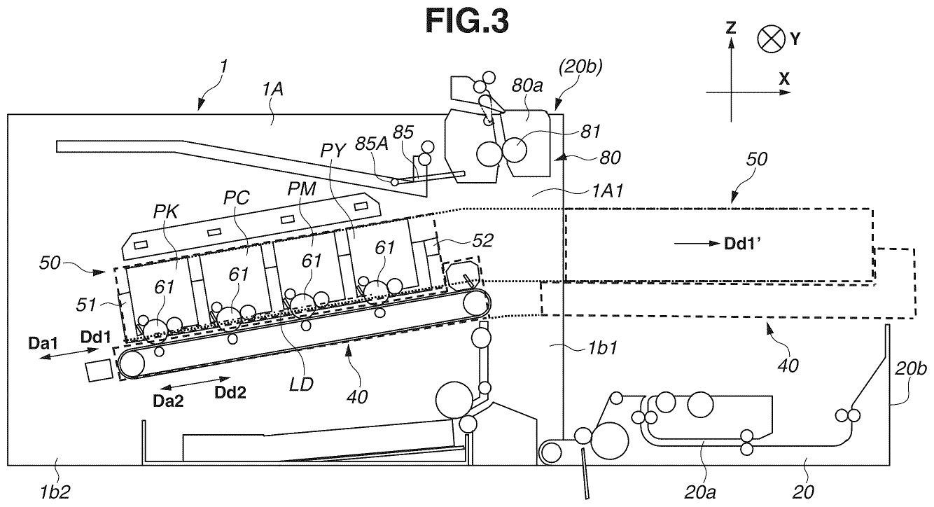

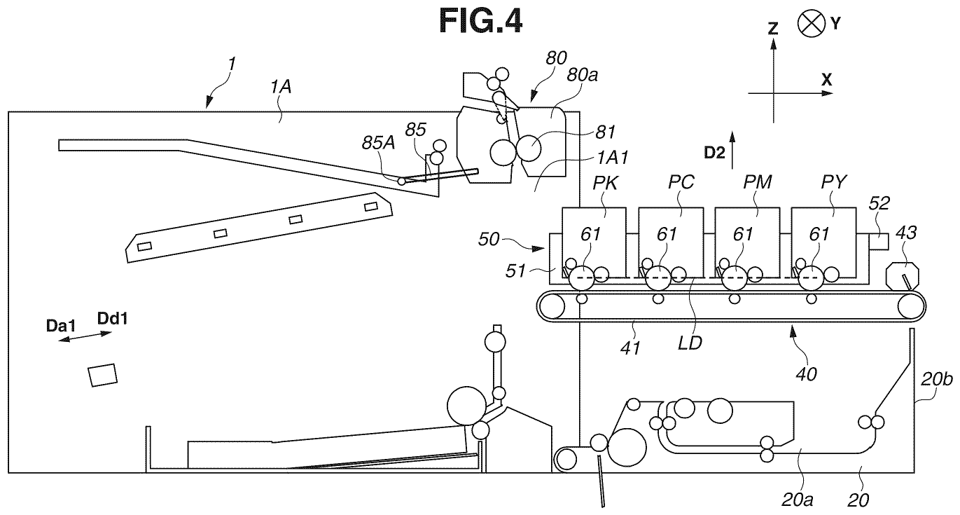

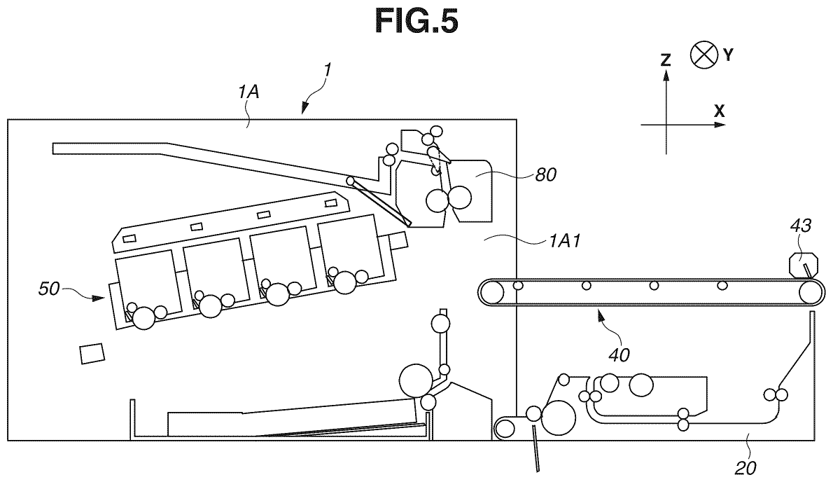

Movements of the transfer unit 40 and the tray unit 50 will be described with reference to FIGS. 1 to 5. FIG. 1 is a diagram illustrating the printer 1 in a state where the door 20 is closed. FIG. 2 is a diagram illustrating the printer 1 in a state where the door 20 is opened. FIG. 3 is a diagram illustrating the printer 1 in a state where the fixing device 80 has been moved to the retracted position. FIG. 4 is a diagram illustrating the printer 1 in a state where the transfer unit 40 and the tray unit 50 have been withdrawn. FIG. 5 is a diagram illustrating the printer 1 in a state where only the transfer unit 40 has been withdrawn.

As illustrated in FIGS. 3 to 5, the transfer unit 40 and the tray unit 50 are configured to move from within the apparatus main body 1A to the outside. The apparatus main body 1A includes a first end portion 1b1 and a second end portion 1b2 opposite to the first end portion 1b1 in the horizontal direction (X-axis direction) in a case where the printer 1 is viewed in the Y-axis direction. The first end portion 1b1 includes an opening 1A1. The tray unit 50 is configured to move between a first inside position inside the apparatus main body 1A and a first outside position outside the apparatus main body 1A through the opening 1A1. The transfer unit 40 is configured to move between a second inside position inside the apparatus main body 1A and a second outside position outside the apparatus main body 1A through the opening 1A1. The opening 1A1 may include an opening configured to allow the tray unit 50 to pass through and another opening configured to allow the transfer unit 40 to pass through. In a case where the transfer unit 40 moves from the second inside position to the second outside position, at least the belt 41 is moved, and at least a portion of the belt 41 projects outward from the apparatus main body 1A.

A tray detachment direction Dd1 refers to the direction in which the tray unit 50 moves from the first inside position toward the first outside position, and a tray attachment direction Da1 refers to a direction opposite to the tray detachment direction Dd1. The tray detachment direction Dd1 is the direction from the second end portion 1b2 toward the first end portion 1b1 in the horizontal direction (X-axis direction). Further, the opening 1A1 is formed in a side surface portion positioned downstream of the apparatus main body 1A (housing) in the tray detachment direction Dd1 (first direction).

In the present exemplary embodiment, the movement direction of the tray unit 50 changes in the course of moving from the first inside position to the first outside position. The change in the movement direction of the tray unit 50 will be described below. The tray detachment direction Dd1 in the following description refers to the movement direction at the start of movement of the tray unit 50 attached to the apparatus main body 1A toward the outside of the apparatus main body 1A. The tray detachment direction Dd1 refers to the movement direction (first direction) during the removal of the tray 51 inserted in the apparatus main body 1A (housing). As a modified example, the tray unit 50 may be configured to move linearly from the first inside position to the first outside position without altering its movement direction.

A transfer detachment direction Dd2 refers to the direction in which the transfer unit 40 moves from the second inside position to the second outside position, and a transfer attachment direction Da2 refers to a direction opposite to the transfer detachment direction Dd2. The drive roller 46 is positioned downstream of the tension roller 47 in the transfer detachment direction Dd2. The transfer detachment direction Dd2 is the direction from the second end portion 1b2 toward the first end portion 1b1 in the horizontal direction (X-axis direction).

The tray detachment direction Dd1 and the tray attachment direction Da1 are directions (desirably orthogonal directions) intersecting the rotational axis direction of the photosensitive drums 61. The transfer detachment direction Dd2 and the transfer attachment direction Da2 are directions (desirably orthogonal directions) intersecting the rotational axis direction of the drive roller 46. The rotational axis direction of the drive roller 46 is parallel to the rotational axis direction of the photosensitive drums 61.

The fixing device 80 described above is disposed at one end side (the side at which the first end portion 1b1 is disposed) of the apparatus main body 1A in the horizontal direction (X-axis direction).

The door 20 is an opening and closing member (cover member, front cover) configured to move between a closed position and an opened position with respect to the apparatus main body 1A. As illustrated in FIG. 1, in a state where the door 20 is at a closed position (a closed state of the door 20), the door 20 is covering the opening 1A1. As illustrated in FIG. 2, in a state where the door 20 is in an opened position (an opened state of the door 20), the opening 1A1 is exposed.

As illustrated in FIG. 1, in a state where the door 20 is at the closed position, the door 20 is covering the fixing device 80 attached to the apparatus main body 1A. More specifically, in a state where the door 20 is at the closed position, an upper cover portion 20b of the door 20 is positioned above the fixing device 80. The upper cover portion 20b of the door 20 functions as a portion of an exterior portion. The printer 1 performs the image forming operation in a state where the door 20 is at the closed position. Withdrawal of the tray unit 50 and the transfer unit 40 from the apparatus main body 1A through the opening 1A1 is permitted in a state where the door 20 is at the opened position.

The door 20 is permitted to move between the opened position and the closed position in a state where the fixing device 80 is supported by the apparatus main body 1A. In other words, the door 20 moves from the closed position to the opened position so that the door 20 moves away from the fixing device 80 supported by the apparatus main body 1A. Therefore, in a state where the door 20 is at the opened position, the door 20 is positioned away from the fixing device 80 supported by the apparatus main body 1A, as illustrated in FIG. 2.

The fixing device 80 is configured to move (retract) from the use position illustrated in FIG. 2 to the retracted position illustrated in FIG. 3 to fully expose the opening 1A1. The transfer unit 40 and the tray unit 50 are permitted to move from within the apparatus main body 1A to the outside through the opening 1A1 in the state after the door 20 and the fixing device 80 have moved (FIG. 3), and the state after movement of the transfer unit 40 and the tray unit 50 is as illustrated in FIG. 4. In other words, in the present exemplary embodiment, withdrawal of the tray unit 50 and the transfer unit 40 from the apparatus main body 1A is permitted in a state where the door 20 is at the opened position and the fixing device 80 is at the retracted position. Alternatively, the fixing device 80 may be fixed to the apparatus main body 1A and withdrawal of the tray unit 50 and the transfer unit 40 from the apparatus main body 1A may be permitted once the door 20 is opened.

Detachment of the cartridges PY, PM, PC, and PK from to the tray 51 and attachment of the cartridges PY, PM, PC, and PK to the tray 51 are permitted in a state where the tray unit 50 is positioned outside the apparatus main body 1A (FIG. 4). Each of the cartridges PY to PK is separated from the tray 51 in a separation direction D2 intersecting the tray detachment direction Dd1. This allows replacement of the cartridges PY, PM, PC, and PK with new cartridges PY, PM, PC, and PK. In the present exemplary embodiment, the cartridge P is attachable to and detachable from the tray 51 in a direction (desirably orthogonal direction) intersecting the rotational axes of the photosensitive drums 61. Specifically, in the present exemplary embodiment, the cartridge P is detached from the tray 51 in an approximately upward direction (approximately the +Z direction) in a state where the tray 51 has been withdrawn from the apparatus main body 1A, whereas the cartridge P is attached to the tray 51 in an approximately downward direction (approximately the −Z direction).

The cartridges PY, PM, PC, and PK are removed from the tray 51 by being moved in a direction away from the transfer unit 40. In other words, the cartridges PY, PM, PC, and PK are removed from the tray 51 by being moved in a direction opposite to the transfer unit 40. In the present exemplary embodiment, the transfer unit 40 is disposed below the tray unit 50. Therefore, the cartridges PY, PM, PC, and PK are removed from the tray 51 by being moved upward relative to the tray 51.

Furthermore, the transfer unit 40 is removable from the apparatus main body 1A independently of the tray unit 50 and can be replaced with a new transfer unit 40.

### Image Forming Operation

An image forming operation will be described with reference to FIG. 1. The image forming operation is a series of operations in which the printer 1 forms an image on a sheet S while conveying the sheet S. The control unit 3 of the printer 1 starts the image forming operation based on image information received from an external host apparatus 90. The external host apparatus 90 is, for example, a personal computer, an image reader, or a facsimile.

When the image forming operation is performed, the fixing device 80, the tray unit 50, the transfer unit 40, and the door 20 are at the use position, the first inside position, the second inside position, and the closed position, respectively. The belt 41 is configured to be brought into contact with the photosensitive drums 61 in a state where the transfer unit 40 is at the second inside position. Image forming positions refer to the positions of the cartridges PY to PK in a case where the tray unit 50 is at the first inside position and the door 20 is at the closed position. The tray unit 50 is positioned above the transfer unit 40 in a case where the tray unit 50 is at the first inside position and the transfer unit 40 is at the second inside position.

When the image forming operation is started, in each station of the tray unit 50, the photosensitive drum 61 is driven and rotated, and the charging roller 62, having a charging voltage applied thereto, uniformly charges the surface of the photosensitive drum 61. Further, the scanner 2 irradiates each photosensitive drum 61 with laser light corresponding to the image information, thereby exposing the surface of the photosensitive drum 61. Consequently, an electrostatic latent image corresponding to an image in which the original image information has been separated into respective CMYK color components is formed on the surface of the photosensitive drum 61.

The development roller 71 rotates while carrying toner. A development voltage is applied to the development roller 71, and the electrostatic latent image formed on the photosensitive drum 61 is developed with the toner supplied from the development roller 71, thereby forming a toner image on the surface of the photosensitive drum 61. In the present exemplary embodiment, the development roller 71 develops the electrostatic latent image while the development roller 71 is in contact with the photosensitive drum 61 (contact development method). However, it is also possible to employ a method in which the development roller 71 develops the electrostatic latent image in a state where a gap is present between the development roller 71 and the photosensitive drum 61. In the case of forming a full-color image, toner images of respective colors are formed on the corresponding photosensitive drums 61.

In the present exemplary embodiment, the development roller 71 is configured to move between a contact position, at which the development roller 71 is brought into contact with the photosensitive drum 61, and a separated position, at which the development roller 71 is separated from the photosensitive drum 61, in a state where the tray unit 50 is at the first inside position. Specifically, a switching device provided to the apparatus main body 1A switches between the state where the development roller 71 is at the contact position and the state where the development roller 71 is at the separated position. This enables separation of the development roller 71 from the photosensitive drum 61 while the image forming operation is not being performed.

Further, the printer 1 can perform monochrome printing in a state where the development roller 71 and the photosensitive drum 61 corresponding to the cartridge PK are in contact with each other while the development rollers 71 and the photosensitive drums 61 corresponding to the cartridges PY, PM, and PC are separated. Further, the printer 1 can perform full-color printing in a state where the photosensitive drums 61 corresponding to the cartridges PY, PM, PC, and PK are in contact with the belt 41.

The toner images formed on the photosensitive drums 61 are transferred onto the belt 41 at the primary transfer portions by the primary transfer rollers 42. The toner images borne on the belt 41 are conveyed toward the secondary transfer portion formed by the belt 41 and the secondary transfer roller 45.

Meanwhile, the apparatus main body 1A includes a conveyance path 1c (first path, first conveyance path) formed to extend from the feed roller 32 through the secondary transfer portion toward the fixing device 80. Further, the door 20 includes a duplex conveyance path (second path, second conveyance path) 20a through which a sheet S passes after passing through the fixing device 80. The door 20 covers the conveyance path 1c in the closed state. Once the door 20 is opened, at least a portion of the conveyance path c and at least a portion of the duplex conveyance path 20a are exposed (FIG. 2).

During the image forming operation, a sheet S is singly fed from the sheet feed unit 30 through the conveyance path 1c toward the secondary transfer portion in parallel with the toner image formation described above. Specifically, the uppermost one of the sheets S stacked on the loading tray 31 is fed out at a predetermined timing by the feed roller 32. The fed sheet S is separated by a separation member, such as a friction roller, undergoes skew correction and timing adjustment performed by the pair of registration rollers 4, and then conveyed to the secondary transfer portion. At the secondary transfer portion, a voltage is applied to the secondary transfer roller 45, thereby transferring the toner image from the belt 41 onto the sheet S. The toner that has not been transferred to the sheet S is removed from the belt 41 by a cleaning blade 43A (cleaning member) provided in the cleaning portion 43.

The sheet S with the toner image transferred at the secondary transfer portion is conveyed to the fixing device 80. The sheet S is heated and pressed at the fixing portion 81, thereby fixing the toner image to the sheet S. After passing through the fixing portion 81, the sheet S arrives at the switching guide 5 as a path switching portion.

The switching guide 5 is configured to move between a sheet-discharge position and a reversal position. The sheet S after passing through the fixing device 80 is guided toward a sheet discharge path 1d in a case where the switching guide 5 is at the sheet-discharge position, or toward a reversal path 1e in a case where the switching guide 5 is at the reversal position. In the case of performing one-sided printing to form an image on one side of the sheet S, the sheet S is guided to the sheet discharge path 1d by the switching guide 5 and discharged to a sheet discharge tray If formed at an upper portion of the apparatus main body 1A. On the other hand, in the case of performing two-sided printing to form images on both sides of the sheet S, the sheet S is guided to the reversal path 1e by the switching guide 5. After the sheet S is guided to the reversal path 1e, the conveyance direction of the sheet S is reversed, and the sheet S is conveyed through the duplex conveyance path 20a formed on the door 20 toward the secondary transfer portion. Thereafter, a toner image is transferred onto the back side of the sheet S at the secondary transfer portion, and then the sheet S is conveyed through the fixing device 80, guided to the sheet discharge path 1d by the switching guide 5, and discharged to the sheet discharge tray 1f of the apparatus main body 1A.

### Removal of Tray Unit and Transfer Unit and Arrangement of Fixing Device

Removal of the tray unit 50 and the transfer unit 40 from the apparatus main body 1A and an arrangement of the fixing device 80 will be described with reference to FIGS. 1-5.

As described above, the fixing device 80 of the printer 1 is disposed at one end of the apparatus main body 1A in the horizontal direction. Further, the transfer unit 40 and the tray unit 50 move from one end of the apparatus main body 1A to the outside of the apparatus main body 1A through the opening 1A1.

In other words, the fixing device 80 is closer to the first end portion 1b1 than to the second end portion 1b2 in the horizontal direction (X-axis direction). Specifically, in the horizontal direction (X-axis direction), the distance between the fixing device 80 and the first end portion 1b1 is shorter than the distance between the fixing device 80 and the second end portion 1b2. The fixing device 80 is disposed closer to the first end portion 1b1 than the center of the apparatus main body 1A in the horizontal direction (X-axis direction) is, and the distance between the first end portion 1b1 and the fixing device 80 in the horizontal direction is shorter than the distance between the first end portion 1b1 and the center of the apparatus main body 1A in the horizontal direction.

Further, as described above, the movement direction of the tray unit 50 when the tray unit 50 moves from the first inside position to the first outside position is a direction intersecting the rotational axes of the photosensitive drums 61. At this time, the tray unit 50 moves away from the second end portion 1b2.

As described above, the movement direction of the transfer unit 40 when the transfer unit 40 moves from the second inside position to the second outside position is a direction intersecting the rotational axis of the drive roller 46. At this time, the transfer unit 40 moves away from the second end portion 1b2.

As described above, in the present exemplary embodiment, the door 20 in the closed state covers the opening 1A1 and at least a portion of the conveyance path 1c for the sheet S. Further, the door 20 includes the duplex conveyance path 20a.

In a case where the sheet S is jammed (hereinafter, referred to as “jam”), a user of the printer 1 can clear the jam by removing the sheet S from one end side of the apparatus main body 1A. Specifically, the sheet S can be removed by moving the door 20 to the opened position and accessing the inside of the apparatus main body 1A. Further, in a case where a portion of the sheet S having passed through the fixing device 80 is exposed outside the apparatus main body 1A, the sheet S can be removed without opening the door 20 by the pulling the sheet S from outside the apparatus main body 1A.

Furthermore, the user of the printer 1 can move the transfer unit 40 and the tray unit 50 from one end side of the apparatus main body 1A to the outside of the apparatus main body 1A and check the state of the transfer unit 40 or the cartridge P or perform an operation such as maintenance or replacement.

In other words, in the printer 1, the fixing device 80 is disposed at one end side of the apparatus main body 1A, and the transfer unit 40 and the tray unit 50 are configured to move between the inside and the outside of the apparatus main body 1A through the one end side of the apparatus main body 1A. This enables the user to clear a jam, access the fixing device 80, and operate the transfer unit 40 and the tray unit 50 from one direction.

In the present exemplary embodiment, the side (+X side) on which the door 20 is provided is defined as the front side of the printer 1. Thus, it is sufficient to provide a space for jam clearance or operation of the transfer unit 40 and the tray unit 50 from the front side of the printer 1. On the other hand, space for performing the foregoing operations from the left, right, rear, or top side of the printer 1 may be omitted. This enables the printer 1 to be installed in a reduced space.

For example, in a case where the transfer unit 40 or the tray unit 50 is configured to be withdrawn from the other end side of the apparatus main body 1A, the user needs to access both end sides of the apparatus main body 1A for jam clearance and withdrawal of the transfer unit 40 or the tray unit 50. Further, in a case where one of the transfer unit 40 and the tray unit 50 is configured to be withdrawn from one end side of the apparatus main body 1A and the other one of the transfer unit 40 and the tray unit 50 is configured to be withdrawn from the other end side, the user also needs to access both end sides of the apparatus main body 1A. This necessitates space for operation not only from the front side but also from the rear side of the apparatus main body 1A, resulting in an increased installation area required for the printer 1.

Furthermore, in the present exemplary embodiment, replenishment of sheets S can be performed from one end side of the apparatus main body 1A. Thus, it is sufficient to provide a space for replenishment of sheets S from the front side of the printer 1, enabling the printer 1 to be installed in a reduced space.

### Relationship between Tray Unit and Fixing Device

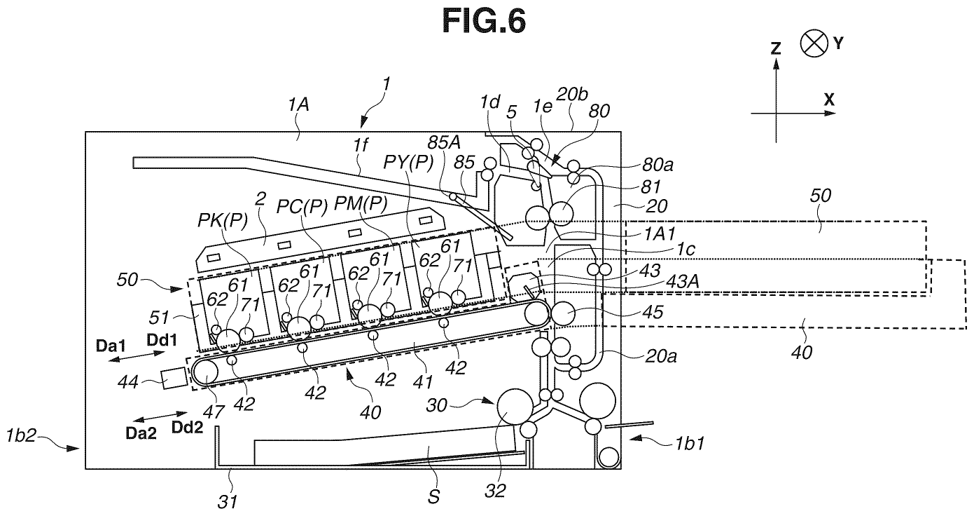

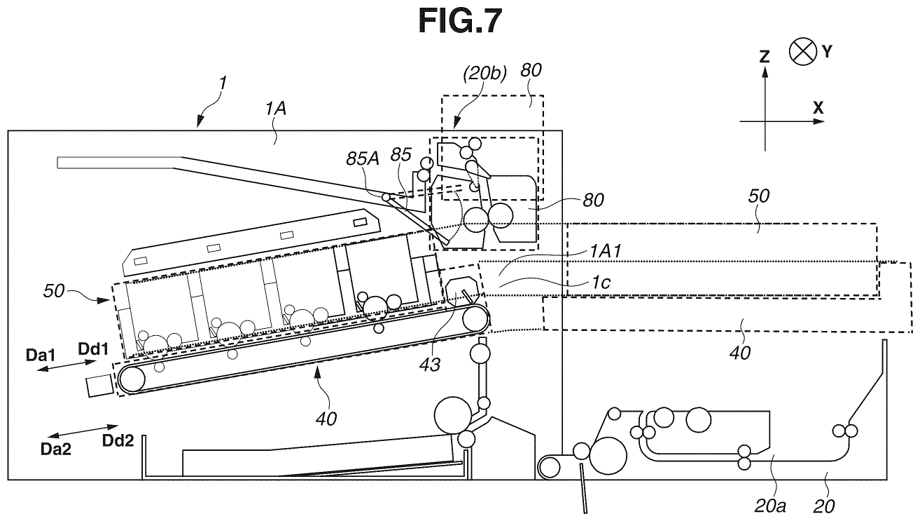

A relationship between the tray unit 50 and the fixing device 80 will be described with reference to FIGS. 1-4, 6, and 7. FIGS. 6 and 7 are diagrams illustrating movement of the transfer unit 40 and the tray unit 50.

The tray unit 50 passes through a predetermined space while moving between the first inside position, in which the image forming operation is performed, and the first outside position, which permits replacement of the cartridge P. The space through which the tray unit 50 passes while moving from the first inside position to the first outside position will be referred to as a first space (movement space for the tray unit 50). The first space may also be referred to as a path or trajectory (first movement path, first movement trajectory) through which the tray unit 50 passes while moving from the first inside position to the first outside position.

The transfer unit 40 passes through a predetermined space while moving between the second inside position, in which the image forming operation is performed, and the second outside position. The space through which the transfer unit 40 passes while moving from the second inside position to the second outside position will be referred to as a second space (movement space for the transfer unit 40). The second space may also be referred to as a path or trajectory (second movement path, second movement trajectory) through which the transfer unit 40 passes while moving from the second inside position to the second outside position.

The relationship among the position (use position) of the fixing device 80, the first space, and the second space during performance of the image forming operation is as follows.

As illustrated in FIGS. 6 and 7, at least a portion of the fixing device 80 overlaps the first space. In other words, in a state where the fixing device 80 is at the use position, at least a portion of the fixing device 80 is located within the first space. This enables a reduction in the size of the apparatus main body 1A compared to a configuration in which the fixing device 80 positioned at the use position is located outside the first space.

Although at least a portion of the fixing device 80 overlaps the space through which the cartridge P passes while the tray unit 50 moves from the first inside position to the first outside position in the present exemplary embodiment, an arrangement may be made so that at least a portion of the fixing device 80 overlaps the space through which the tray 51 passes.

As illustrated in FIG. 6, in the present exemplary embodiment, at least a portion of the duplex conveyance path 20a overlaps the first space when the door 20 is in the closed state. In other words, at least a portion of the duplex conveyance path 20a is located within the first space when the door 20 is in the closed state.

As described above, at least a portion of the fixing device 80 positioned at the use position is located within the first space. Thus, in the state where the fixing device 80 is at the use position, movement of the tray unit 50 from the first inside position to the first outside position is restricted. Further, the fixing device 80 is configured to retract from the use position to the retracted position located above the use position. In a state where the fixing device 80 is retracted from the use position, the tray unit 50 is permitted to move from the first inside position to the first outside position. The tray unit 50 passes below the fixing device 80 when moving from the first inside position to the first outside position.

The fixing device 80 is positioned outside the second space both at the use position and the retracted position. Thus, the transfer unit 40 is permitted to move from the second inside position to the second outside position in either of a state where the fixing device 80 is at the use position and a state where the fixing device 80 is at the retracted position. The transfer unit 40 passes below the fixing device 80 when moving from the second inside position to the second outside position.

The fixing device 80 includes a fixing frame 80a configured to support the fixing portion 81. During retraction of the fixing device 80 from the use position, the fixing frame 80a is displaced relative to the apparatus main body 1A while supporting the fixing portion 81.

To withdraw the tray unit 50 to the outside of the apparatus main body 1A, first, the user moves the door 20 to the opened position as illustrated in FIG. 2. In the present exemplary embodiment, the door 20 is permitted to move between the opened position and the closed position in a state where the fixing device 80 is at the use position. Then, the fixing device 80 is moved from the use position to the retracted position in a state where the door 20 is at the opened position so that the fixing device 80 is retracted to the outside of the first space as illustrated in FIG. 3.

In the printer 1 according to the present exemplary embodiment, the fixing device 80 is permitted to move between the use position and the retracted position, which is retracted from the use position, in a state where the fixing device 80 is attached to the apparatus main body 1A. In the present exemplary embodiment, when positioned at the retracted position, the fixing device 80 is entirely outside the first space.

The fixing device 80 is lifted from the use position and positioned at the retracted position located above the use position. In other words, the retracted position is a position higher than the use position. As illustrated in FIG. 7, when the fixing device 80 is at the retracted position, at least a portion of the fixing device 80 projects outward from the apparatus main body 1A. Furthermore, when the fixing device 80 is at the retracted position, at least a portion of the fixing device 80 is higher in position than the upper cover portion 20b of the door 20 positioned at the closed position. This allows the printer 1 to maintain a small size in the vertical direction Z when the fixing device 80 is at the use position while securing a space for movement of the tray unit 50 by moving the fixing device 80 to the retracted position. The door 20 is restricted from reaching the closed position in a state where that the fixing device 80 is at the retracted position.

Specifically, the printer 1 includes a connecting member (fixing link, arm) 85 is movably connected to the apparatus main body 1A. The fixing device 80 is connected to the apparatus main body 1A via the connecting member 85.

The connecting member 85 is configured to rotate about a rotation center 85A, and the connecting member 85 is moved outside the first space during withdrawal of the tray unit 50 to outside the apparatus main body 1A. The fixing device 80 is rotatably connected to one end of the connecting member 85, and the other end of the connecting member 85 is connected to the apparatus main body 1A so that the connecting member 85 is rotatable about the rotation center 85A. The fixing device 80 is configured to move from the use position to the retracted position and to move from the retracted position to the use position in a state where the fixing device 80 is supported by the connecting member 85 (a state where fixing device 80 is connected to the apparatus main body 1A via the connecting member 85). The connecting member 85 is configured to move (swing) relative to the apparatus main body 1A and the fixing device 80. In other words, the fixing device 80 is connected to the apparatus main body 1A via the connecting member 85. This enables an increased amount of movement of the fixing device 80 during movement of the fixing device 80 between the retracted position and the use position, compared to a configuration in which the fixing device 80 is directly connected to the apparatus main body 1A.

As illustrated in FIG. 7, during movement of the tray unit 50 from the first inside position to the first outside position, an angle formed between the movement direction of the tray unit 50 and the horizontal direction X is smaller than an angle formed between the movement direction of the tray unit 50 and the vertical direction Z. Furthermore, during movement of the fixing device 80 from the use position to the retracted position, the amount of movement of the fixing device 80 is greater in the vertical direction Z than in the horizontal direction X. In other words, during movement of the fixing device 80 from the use position to the retracted position, the amount of movement of the fixing device 80 is greater in a direction perpendicular to the movement direction of the tray unit 50 than in a direction parallel to the movement direction of the tray unit 50.

Furthermore, the fixing device 80 may be configured to move between the use position and the retracted position in a state where the fixing device 80 is attached to the apparatus main body 1A via a guide fixed to the apparatus main body 1A. In this case, the guide may have an arbitrary shape.

The above-described example is not intended to limit the method of moving the fixing device 80 out of the first space. For example, the fixing device 80 may be configured to be removable from the apparatus main body 1A in order to retract from the use position, thereby moving the fixing device 80 out of the first space. In other words, the fixing device 80 may be moved outside the first space by separating the fixing device 80 from the apparatus main body 1A and the door 20 (by separating the fixing device 80 from the main frame 100). Further, the fixing device 80 may be connected to the door 20, and opening the door 20 may cause the fixing device 80 to move to a position outside the first space.

### Moving Member

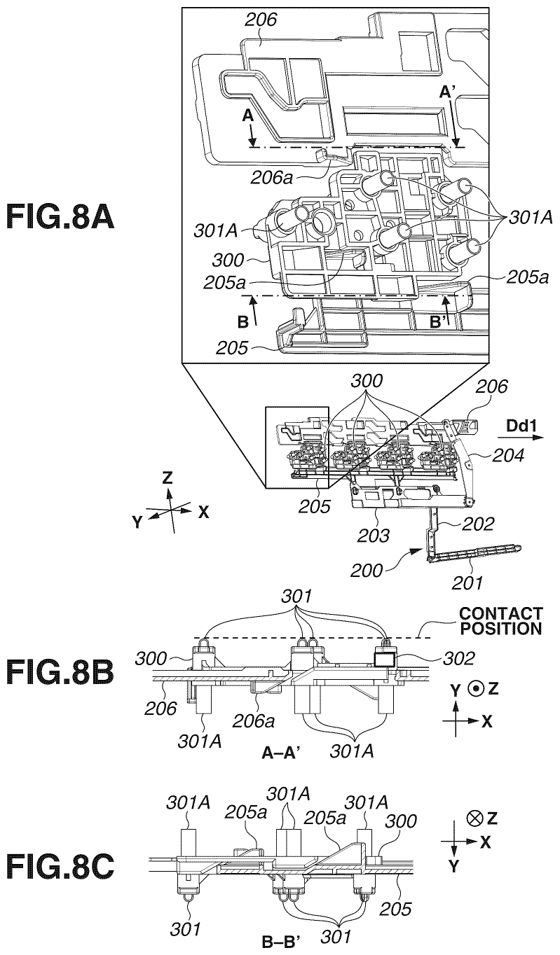

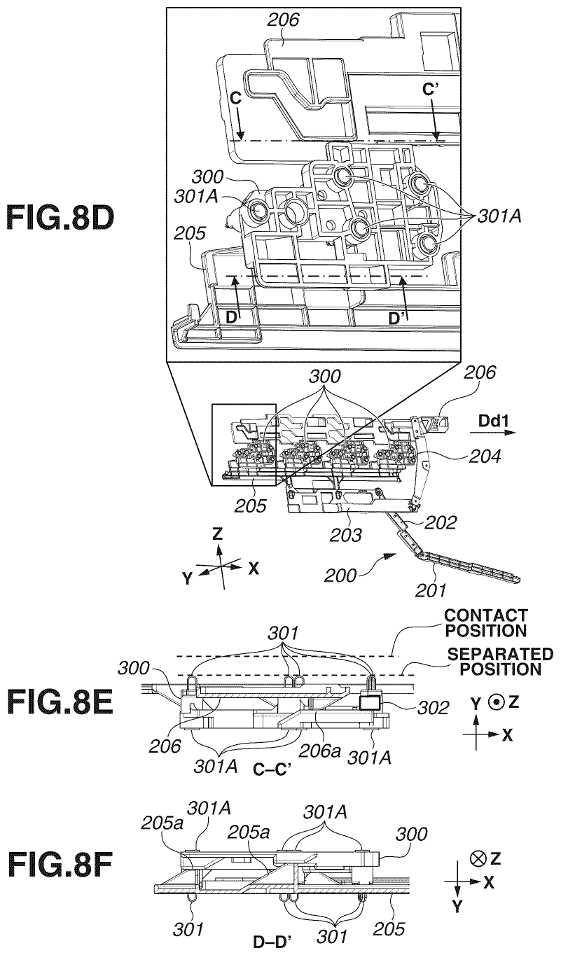

A movable member 300 and a link mechanism 200 configured to link the movable member 300 to the opening and closing of the door 20 will be described with reference to FIGS. 8A to 8F. FIGS. 8A and 8D are perspective views illustrating the movable member 300 and the link mechanism 200 and enlarged views of that portion. FIG. 8B is a cross-sectional view illustrating the movable member 300 and the link mechanism 200 along line A-A′ in FIG. 8A. FIG. 8C is a cross-sectional view illustrating the movable member 300 and the link mechanism 200 along line B-B′ in FIG. 8A. FIG. 8E is a cross-sectional view illustrating the movable member 300 and the link mechanism 200 along line C-C′ in FIG. 8D. FIG. 8F is a cross-sectional view illustrating the movable member 300 and the link mechanism 200 along line D-D′ in FIG. 8D.

As illustrated in FIG. 8A, the printer 1 includes the movable member 300 and the link mechanism 200. The movable member 300 and the link mechanism 200 are disposed on the apparatus main body 1A. The movable member 300 is a restriction member configured to restrict movement in the direction (separation direction D2) in which the cartridge P is separated from the tray 51, as described below.

The apparatus main body 1A may include a plurality of movable members 300 corresponding to a plurality of cartridges P attached to the tray 51. The apparatus main body 1A according to the present exemplary embodiment includes four movable members 300 corresponding to four cartridges P. In other words, the apparatus main body 1A according to the present exemplary embodiment includes a first movable member 300 corresponding to a yellow cartridge PY, a second movable member 300 corresponding to a magenta cartridge PM, a third movable member 300 corresponding to a cyan cartridge PC, and a fourth movable member 300 corresponding to a black cartridge PK. The ordinals “first” to “fourth” are used for convenience only and are not intended to denote a specific sequence. Further, the number of movable members 300 may be less than the number of cartridges P, and the movable member 300 may be disposed only for some of the cartridges P.

The four movable members 300 is disposed in alignment along the tray detachment direction Dd1 (first direction). In other words, in the present exemplary embodiment, the tray 51 and the cartridges PY to PK are moved from the first inside position (FIG. 3) toward the first outside position (FIG. 4) along the direction along which the plurality of movable members 300 is aligned.

The four movable members 300 are configured substantially identically, except that the cartridges P for which movement is restricted differ from each other. Thus, in the following description, the term “the movable member 300” refers to any one of the four movable members 300.

The movable member 300 is configured to move relative to the apparatus main body 1A between a first position (projected position, restriction position) illustrated in FIGS. 8A to 8C and a second position (retracted position, restriction release position) illustrated in FIGS. 8D to 8F. The movable member 300 is configured to move between the first position and the second position in a direction (third direction) intersecting both the tray detachment direction Dd1 (first direction) and the separation direction D2 (second direction) of the cartridge P. The movable member 300 according to the present exemplary embodiment moves in the Y-axis direction orthogonal to both the tray detachment direction Dd1 and the separation direction D2.

The first position is the position of the movable member 300 when the door 20 is at the closed position. The second position is the position of the movable member 300 when the door 20 is at the opened position. In the present exemplary embodiment, the second position is a position obtained by moving from the first position in the −Y direction. The second position is also referred to as a position retracted from the first position in the Y-axis direction toward the side (−Y side) away from the end surface of the cartridge P attached to the apparatus main body 1A together with the tray 51.

The movable member 300 according to the present exemplary embodiment has a role of moving a main-body contact 301 disposed in the apparatus main body 1A in association with the opening and closing of the door 20. The movable member 300 is also referred to as a holder member configured to support the main-body contact 301 and move the main-body contact 301. The main-body contact 301 is a component (first contact, electrified portion, power supply portion) for electrically connecting an electric circuit of the apparatus main body 1A and an electric circuit of the cartridge P. In the present exemplary embodiment, the movable member 300 is engaged with a plurality of main-body contacts 301 and simultaneously moves the plurality of main-body contacts 301.

Each main-body contact 301 is disposed at a position corresponding to a cartridge contact (second contact) provided on the cartridge P. An example of the cartridge P including a cartridge contact (second contact) will be described below with reference to FIGS. 17 to 24. Each main-body contact 301 is configured to move between a position (contact position) at which the main-body contact 301 is in contact with a cartridge contact and a position (separated position) at which the main-body contact 301 is separated from the cartridge contact. The separated position is also referred to as a position retracted from the contact position in the Y-axis direction toward the side (−Y side) away from the end surface of the cartridge P attached to the apparatus main body 1A together with the tray 51.

In the present exemplary embodiment, each main-body contact 301 is disposed at an end portion of a contact spring 301A. The contact spring 301A is an elastic member that is elastically deformable (expandable and contractible) in the Y-axis direction. The contact spring 301A may be a coil spring extending in the Y-axis direction. Further, each main-body contact 301 may be integrally formed with the contact spring 301A by bending and raising an end portion of a spring wire of a coil spring into a U-shape. The contact spring 301A may constitute a portion of a conductive path for supplying power to the cartridge P through the main-body contact 301 or transmitting and receiving an electrical signal to and from the cartridge P through the main-body contact 301.

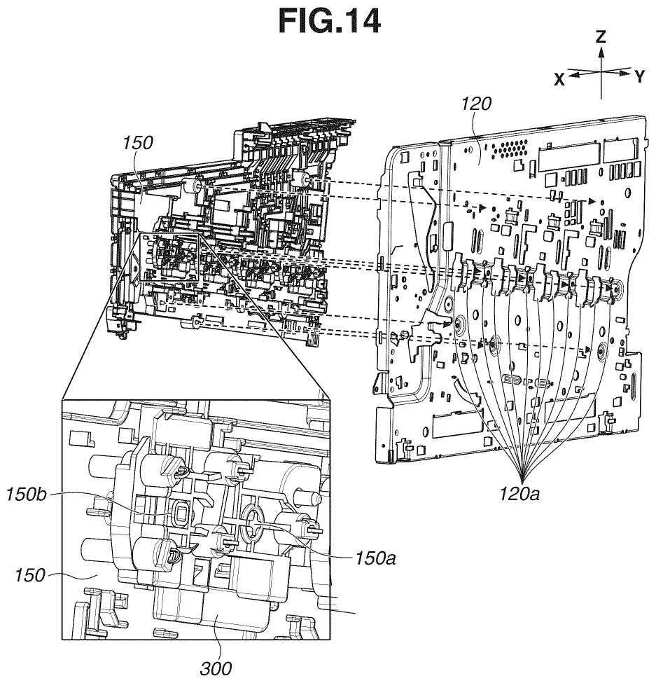

Each main-body contact 301 is urged in the +Y direction, which is a direction from the separated position toward the contact position, by a restorative force (spring force) of the contact spring 301A. The movable member 300 is brought into contact with an end surface of the contact spring 301A in the +Y direction, thereby determining the position of the main-body contact 301. Further, a through hole is formed in the movable member 300, and each main-body contact 301 is exposed (projected) from the movable member 300 in the +Y direction through the through hole. The through hole is formed in a bottom portion of a contact holding portion 300a (also refer to FIG. 14) having a substantially cylindrical shape with a bottom surface and holding the end portion of the contact spring 301A on the +Y side.

The movable member 300 is moved in association with the opening and closing of the door 20 by the link mechanism 200 described below, thereby moving each main-body contact 301 between the contact position and the separated position. In other words, the movable member 300 moves each main-body contact 301 (first contact) between the contact position at which the main-body contact 301 is in contact with the cartridge contact (second contact) and the separated position at which the main-body contact 301 is separated from the cartridge contact (second contact). In the present exemplary embodiment, the single link mechanism 200 moves all of the four movable members 300.

As illustrated in FIGS. 8A and 8D, the link mechanism 200 includes a first link 201, a second link 202, a third link 203, a fourth link 204, a fifth link 205, and a sixth link 206. Each of the links 201 to 206 is movably supported by the apparatus main body 1A.

The first link 201 is connected to the door 20 and moves in association with the opening and closing of the door 20. The second link 202 is connected to the first link 201 and rotates about a predetermined rotational axis in association with the movement of the first link 201. The third link 203 is connected to the second link 202 and moves in a direction along the X-axis direction in association with the rotation of the second link 202. The fourth link 204 is connected to the third link 203 and rotates about a predetermined rotational axis in association with the third link 203. The fifth link 205 is connected to the third link 203 and reciprocates along the X-axis direction in association with the rotation of the third link 203. The sixth link 206 is connected to the fourth link 204 and reciprocates along the X-axis direction in association with the rotation of the fourth link 204.

The fifth link 205 and the sixth link 206 both move along the X-axis but in opposite directions. In other words, in a case where the door 20 is moved from the closed position to the opened position (FIG. 8A to FIG. 8D), the fifth link 205 moves in the −X direction whereas the sixth link 206 moves in the +X direction. Further, in a case where the door 20 is moved from the opened position to the closed position (FIG. 8D to FIG. 8A), the fifth link 205 moves in the +X direction whereas the sixth link 206 moves in the −X direction.

The fifth link 205 and the sixth link 206 respectively include cam surfaces 205a and 206a configured to be brought into contact with the movable member 300. The cam surfaces 205a and 206a are surfaces facing the −Y direction and inclined in the +Y direction toward the movement direction of the fifth link 205 and the sixth link 206 during movement of the door 20 from the closed position to the opened position. In other words, the cam surface 205a of the fifth link 205 is inclined in the +Y direction toward the −X direction, which is the movement direction of the fifth link 205 during movement of the door 20 from the closed position to the opened position. The cam surface 206a of the sixth link 206 is inclined in the +Y direction toward the +X direction, which is the movement direction of the sixth link 206 during movement of the door 20 from the closed position to the opened position.

In a case where the door 20 is moved from the closed position to the opened position, the cam surfaces 205a and 206a of the fifth link 205 and the sixth link 206 press the movable member 300 in the −Y direction to move the movable member 300 from the first position to the second position (FIG. 8A to FIG. 8D). The movement of the movable member 300 from the first position to the second position causes each main-body contact 301 to move in the −Y direction against the restorative force of the contact spring 301A (FIG. 8B, 8C to FIG. 8E, 8F). Consequently, each main-body contact 301 moves from the contact position to the separated position.

As described above, in association with the movement of the door 20 from the closed position to the opened position, the movable member 300 is configured to move from the first position to the second position, and each main-body contact 301 is configured to move from the contact position to the separated position.

In a case where the door 20 is closed, the movement directions of the above-described members are reversed. In other words, in a case where the door 20 is moved from the opened position to the closed position, the fifth link 205 and the sixth link 206 releases the pressing of the movable member 300 by the cam surfaces 205a and 206a. Consequently, the movable member 300 moves in the +Y direction in accordance with the restorative force of the contact spring 301A, thereby moving from the second position to the first position (FIG. 8D to FIG. 8A). Further, the movement of the movable member 300 form the second position to the first position permits each main-body contact 301 to move in the +Y direction in accordance with the restorative force of the contact spring 301A (FIG. 8E, 8F to FIG. 8B, 8C). Consequently, each main-body contact 301 moves from the separated position to the contact position.

In the present exemplary embodiment, the movable member 300 linearly moves in the Y-axis direction in association with the opening and closing of the door 20 without rotating. This configuration is suitable for moving a plurality of main-body contacts 301 between the contact position and the separated position using a single movable member 300. However, the movable member 300 may be configured to rotate in association with the opening and closing of the door 20. For example, in a case where a single movable member 300 is configured to move a single main-body contact 301, employing a movable member 300 configured to rotate may simplify the configuration of the link mechanism 200.

### Position of Movable Member

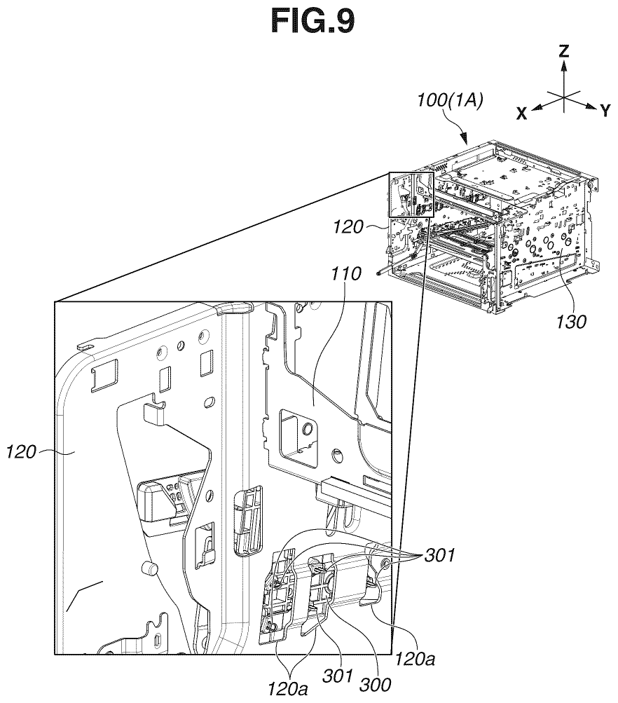

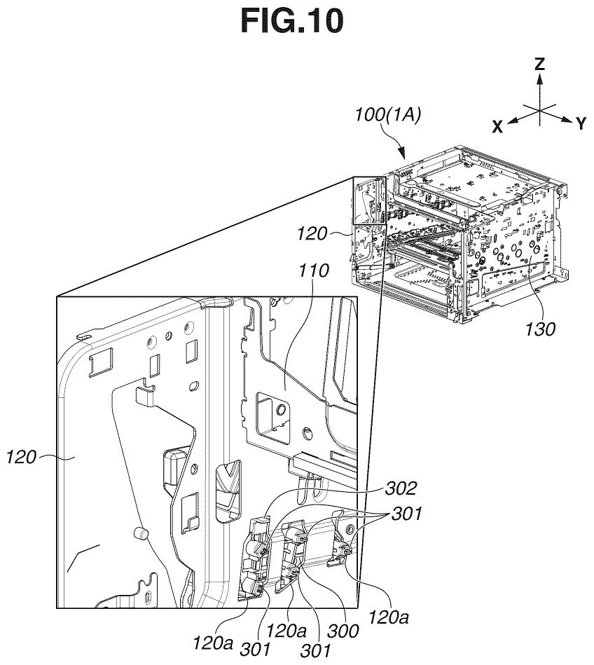

Next, an arrangement of the movable member 300 in the apparatus main body 1A and a positional relationship between the movable member 300 and the cartridge P will be described with reference to FIGS. 9 and 10. FIGS. 9 and 10 are perspective views illustrating the apparatus main body 1A excluding the exterior housing and enlarged views of portions thereof. FIG. 9 illustrates a state where the movable member 300 is at the second position and the main-body contact 301 is at the separated position. FIG. 10 illustrates a state where the movable member 300 is at the first position and the main-body contact 301 is at the contact position.

As illustrated in FIGS. 9 and 10, the apparatus main body 1A includes a left side plate 120, a right side plate 130, and a main stay 110. The left side plate 120 is an example of a first side plate disposed on one side of the tray 51 in the Y-axis direction (third direction) relative to an accommodating space (tray unit attachment space) configured to accommodate the tray unit 50 inserted into the apparatus main body 1A (housing). The right side plate 130 is an example of a second side plate disposed on another side in the Y-axis direction (third direction) relative to the accommodating space.

The left side plate 120, the right side plate 130, and the main stay 110 are metal (sheet metal) frame members forming the frame of the printer 1. Each of the left side plate 120 and the right side plate 130 has a plate shape extending in the direction intersecting the Y-axis direction (desirably, the X-Z direction substantially orthogonal to the Y-axis direction). The main stay 110 extends along the Y-axis direction and is secured to both the left side plate 120 and the right side plate 130.

The left side plate 120 is formed with an opening portion 120a. The opening portion 120a is a through hole penetrating the left side plate 120 in the Y-axis direction or a cutout shape. When viewed from the accommodating space side of the tray unit 50 (i.e., from the +Y side relative to the left side plate 120), the main-body contact 301 is exposed inside the opening portion 120a.

In the present exemplary embodiment, the number of main-body contacts 301 corresponding to one cartridge P in the apparatus main body 1A is five. The left side plate 120 is formed with three opening portions 120a, and each of the five main-body contacts 301 is exposed inside any of the three opening portions 120a. The left side plate 120 is formed with a plurality of opening portions 120a so that each of the main-body contacts 301 corresponding to the four cartridges PY to PK is exposed inside any of the opening portions 120a. However, the number and arrangement of main-body contacts 301 corresponding to one cartridge P and the number and arrangement of main-body contacts 301 exposed inside one opening portion 120a are not limited to those illustrated.

In a case where the main-body contact 301 is at the contact position (FIG. 10), the main-body contact 301 projects toward the accommodating space of the tray unit 50 through the opening portion 120a relative to the left side plate 120. In other words, the main-body contact 301 positioned at the contact position projects toward the inside (+Y side) of the accommodating space relative to the left side plate 120 forming a left-side (−Y side) wall surface of the accommodating space of the tray unit 50.

In a case where the main-body contact 301 is at the separated position (FIG. 9), the main-body contact 301 is retracted from the contact position toward the −Y side away from the accommodating space of the tray unit 50. In a case where the main-body contact 301 is at the separated position, the main-body contact 301 may be retracted to the outside (−Y side) of the accommodating space relative to the left side plate 120.

A positional relationship between the movable member 300 and the cartridge P during the operations of opening the door 20, inserting and withdrawing the tray unit 50, and closing the door 20 will be described.

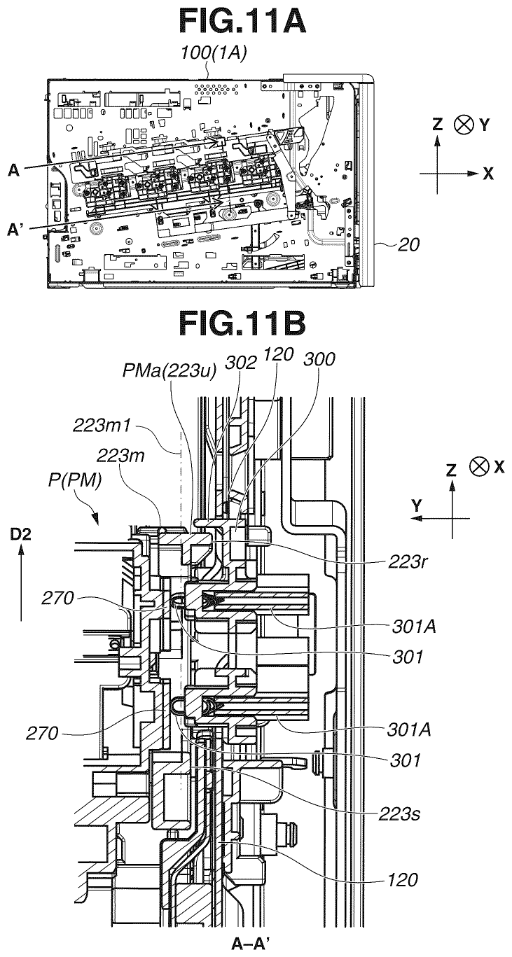

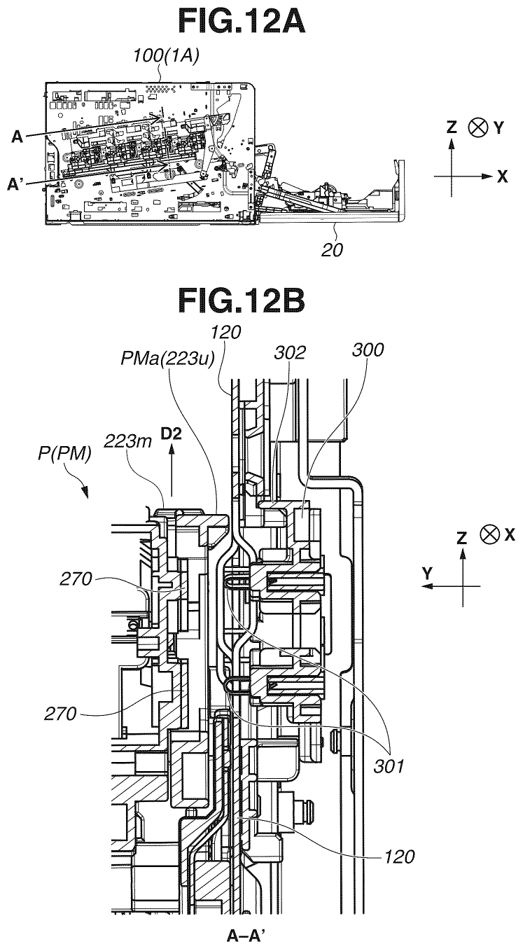

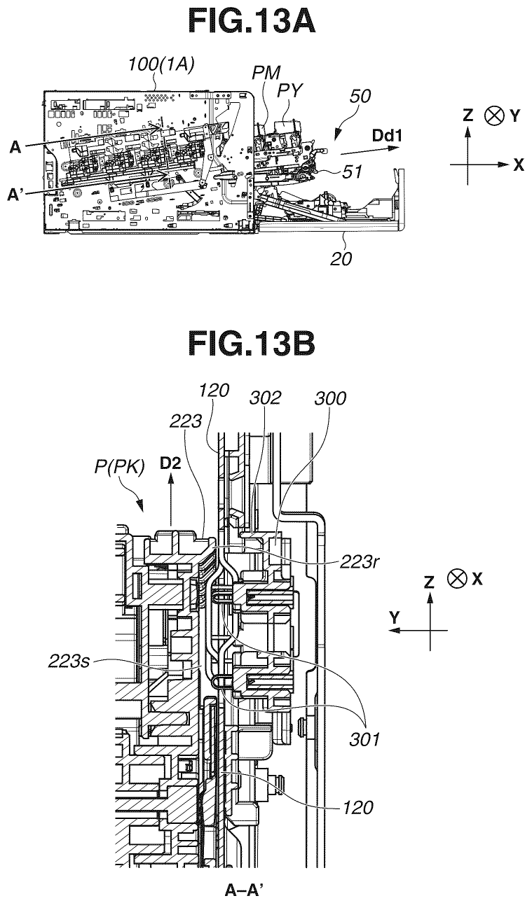

FIG. 11A is an outline view illustrating the printer 1 in a state where the door 20 is at the closed position and the tray unit 50 is inserted in the first inside position of the apparatus main body 1A. FIG. 11B is a cross-sectional view along line A-A′ in FIG. 11A. FIG. 12A is an outline view illustrating the printer 1 in a state where the door 20 is at the opened position and the tray unit 50 remains inserted in the first inside position of the apparatus main body 1A. FIG. 12B is a cross-sectional view along line A-A′ in FIG. 12A. FIG. 13A is an outline view illustrating the printer 1 in a state where the door 20 is at the opened position and the tray unit 50 is withdrawn from the apparatus main body 1A to the first outside position. FIG. 13B is a cross-sectional view along line A-A′ in FIG. 13A.

FIGS. 11B, 12B, and 13B illustrate cross sections through the magenta cartridge PM, as an example of the cartridge P, and the movable member 300 corresponding to the magenta cartridge PM. However, the configuration of the movable member 300 and the positional relationship between the movable member 300 and the cartridge PM in a case where the tray unit 50 is at the first inside position also apply to the other cartridges PY, PC, and PK.

As illustrated in FIG. 11B, the movable member 300 includes a restriction portion 302. The restriction portion 302 is a projecting portion that projects toward the +Y direction (i.e., toward the accommodating space of the tray unit 50). The restriction portion 302 moves in the Y-axis direction together with the other portion of the movable member 300. In other words, the position of the restriction portion 302 in a case where the movable member 300 is at the first position (projected position, restriction position) is positioned in the +Y direction relative to the position of the restriction portion 302 in a case where the movable member 300 is at the second position (retracted position, restriction release position). The restriction portion 302 is schematically illustrated in FIGS. 8B and 8E.

In a case where the movable member 300 is at the first position, the restriction portion 302 projects through the opening portion 120a of the left side plate 120 toward the +Y side (i.e., toward the accommodating space of the tray unit 50) from the surface of the left side plate 120 on the +Y side (FIG. 10). In a case where the movable member 300 is at the second position, the restriction portion 302 is retracted to the −Y side from the surface of the left side plate 120 on the +Y side (FIG. 9). One or more main-body contacts 301 may be disposed in the opening portion 120a of the left side plate 120 where the restriction portion 302 is disposed (FIG. 9, FIG. 10). In other words, the restriction portion 302 and the main-body contact 301 may be disposed together in one opening portion 120a.

As illustrated in FIG. 11A, in a case where the door 20 is at the closed position, the movable member 300 is positioned at the first position as described above.

As illustrated in FIG. 11B, in a state where the tray unit 50 is inserted in the apparatus main body 1A and the movable member 300 is at the first position, the restriction portion 302 overlaps the cartridge PM when viewed in the separation direction D2 of the cartridge PM. The restriction portion 302 is positioned downstream of a restricted surface PMa of the cartridge PM in the separation direction D2. The separation direction D2 is a direction intersecting the tray detachment direction Dd1 (first direction, refer to FIG. 3), in which the tray unit 50 inserted in the apparatus main body 1A is withdrawn, and is the second direction (also refer to FIG. 4) in which the cartridge PM is separated from the tray 51.

In a case where, for example, an impact from a fall is applied to the printer 1 in a state where the tray unit 50 is inserted in the apparatus main body 1A, the cartridge PM may move from the tray 51 in the separation direction D2. Even in this case, since the restriction portion 302 is disposed at a position overlapping the cartridge PM when viewed in the separation direction D2, movement of the cartridge PM is restricted by the restriction portion 302. In other words, each restriction portion 302 is configured to restrict movement (misregistration) of the corresponding cartridge P in the separation direction D2 (second direction).

The restricted surface PMa is an end surface (end surface in the second direction, non-contact surface) of the cartridge P in the separation direction D2. In a state where the tray unit 50 is inserted in the first inside position and the door 20 is at the closed position (FIG. 11B), the restriction portion 302 faces the restricted surface PMa of the cartridge PM and a gap is present between the restriction portion 302 and the restricted surface PMa. The state illustrated in FIG. 11B is a state where the cartridge PM is at an image forming position. The image forming position is the position during image formation. Thus, providing a gap between the restriction portion 302 and the restricted surface PMa prevents the restriction portion 302 from being brought into contact with the cartridge PM and affecting the position or orientation of the cartridge PM during image formation.

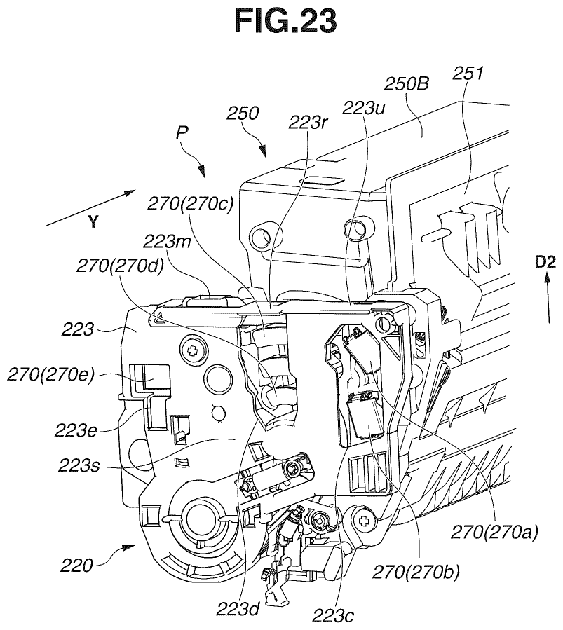

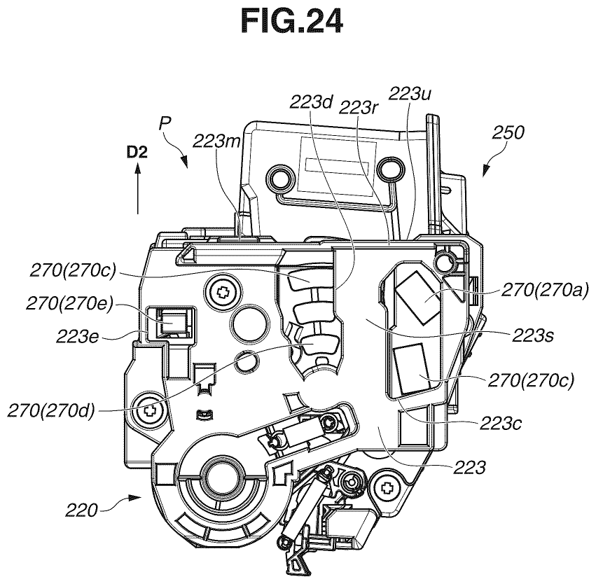

Further, in the present exemplary embodiment, the restriction portion 302 restricts a non-drive side cover 223 (FIG. 23, FIG. 24) provided on an end portion of the cartridge PM on the −Y side (left side). The restricted surface PMa described above is a portion of an end surface 223u of the non-drive side cover 223 on the +Z side (upper side). Further, the restricted surface PMa may be provided on an end surface of a rib structure 223r (FIG. 23, FIG. 24) of the non-drive side cover 223 on the +Z side (upper side). The non-drive side cover 223 and the rib structure 223r will be described below.

As illustrated in FIGS. 12A and 12B, in a case where the door 20 is moved from the closed position to the opened position, the movable member 300 is moved from the first position to the second position in association with the movement of the door 20 by the link mechanism 200. Further, the main-body contact 301 is moved from the contact position to the separated position in association of the movement of the movable member 300 from the first position to the second position.

As illustrated in FIG. 12B, in a state where the tray unit 50 is inserted in the apparatus main body 1A and the movable member 300 is at the second position, the restriction portion 302 does not overlap the cartridge PM when viewed in the separation direction D2 (second direction). The restriction portion 302 is retracted in the −Y direction from the restricted surface PMa of the cartridge PM. In other words, the restriction portion 302 does not interfere with the cartridge PM in a case where the movable member 300 is at the second position.

As illustrated in FIGS. 13A and 13B, after the door 20 is opened, the tray unit 50 is withdrawn from the first inside position toward the first outside position in the tray detachment direction Dd1. In other words, since the door 20 is at the opened position, the tray unit 50 is withdrawn from the apparatus main body 1A in a state where the movable member 300 is at the second position.

In a case where the movable member 300 is at the second position, the restriction portion 302 is retracted from a movement trajectory of the cartridge PM during withdrawal of the tray unit 50 from the apparatus main body 1A. The movement trajectory of the cartridge PM refers to a space (movement path) through which the cartridge PM passes during movement of the tray unit 50 from the first inside position to the first outside position.

This enables smooth insertion and withdrawal of the tray unit 50 relative to the apparatus main body 1A without the cartridge PM interfering with the restriction portion 302.

In other words, the present exemplary embodiment makes it possible to provide an image forming apparatus capable of restricting cartridge misregistration without affecting the operability of a tray.

Further, as illustrated in FIG. 13B, the restriction portion 302 of the movable member 300 corresponding to the magenta cartridge PM is retracted from the movement trajectories of all other cartridges PC and PK that pass near the restriction portion 302 during withdrawal of the tray unit 50. In other words, the position of the restriction portion 302 in a case where the movable member 300 is at the second position is retracted from the movement trajectories of all the plurality of cartridges PY to PK during withdrawal of the tray 51 from the inside position to the outside position.

This enables smooth insertion and withdrawal of the tray unit 50 relative to the apparatus main body 1A without the plurality of cartridges PY to PK interfering with the restriction portion 302.

In the present exemplary embodiment, the movement trajectory during insertion and withdrawal of the tray unit 50 between the first inside position and the first outside position include a change in the movement direction of the tray unit 50. In other words, the movement trajectory of the tray unit 50 differs from a simple trajectory in which the tray unit 50 moves linearly at a constant direction.

Specifically, the tray unit 50 according to the present exemplary embodiment is moved in the tray detachment direction Dd1 (first direction) from the first inside position to a predetermined position between the first inside position and the first outside position illustrated in FIG. 3. Further, the tray unit 50 according to the present exemplary embodiment is moved in a second tray detachment direction Dd1′ (fourth direction) from the predetermined position to the first outside position. The second tray detachment direction Dd1′ has a different inclination angle relative to the horizontal direction from that of the tray detachment direction Dd1. In the present exemplary embodiment, the inclination angle of the tray detachment direction Dd1 relative to the horizontal direction is greater than the inclination angle of the second tray detachment direction Dd1′ relative to the horizontal direction.

Permitting a change in the movement direction of the tray unit 50 during movement from the first inside position to the first outside position increases the degree of design freedom of the printer 1. This makes it possible to reduce the size of the printer 1, for example, by inclining the orientation of the tray unit 50 at the first inside position relative to the horizontal direction to reduce dead space in the apparatus main body 1A. Further, the movement trajectory (first space) of the tray unit 50 can be minimized by setting the tray detachment direction Dd1 to align with the inclined orientation of the tray unit 50. Further, ease of operation during attachment and detachment of the cartridge P to and from the tray 51 from above by the user can be improved by setting the orientation of the tray unit 50 at the first outside position to a horizontal angle or an angle close to horizontal.

More specifically, the predetermined position refers to a position of the tray unit 50 in which the black cartridge PK is positioned between the movable member 300 corresponding to the black cartridge PK and the movable member 300 corresponding to the yellow cartridge PY. In other words, in a case where the tray 51 is positioned at the predetermined position, a first cartridge (PK) is located downstream of a first movable member and upstream of a second movable member in the tray detachment direction Dd1 (first direction), where the first cartridge is the cartridge PK that is located at the most upstream position in the tray detachment direction Dd1 (first direction) among the plurality of cartridges, a second cartridge is the cartridge PK that is located at the most downstream position in the tray detachment direction Dd1 among the plurality of cartridges, the first movable member is the movable member that corresponds to the first cartridge among the plurality of movable members 300, and the second movable member is the movable member that corresponds to the second cartridge among the plurality of movable members 300.

In the configuration in which the movement direction of the tray unit 50 changes during movement of the tray unit 50 from the first inside position to the first outside position as described above, each of the plurality of cartridges PY to PK passes through a different position from one another in the separation direction D2 (second direction) intersecting the tray detachment direction Dd1. For example, as illustrated in FIG. 13B, the position through which the black cartridge PK passes while passing near the restriction portion 302 corresponding to the magenta cartridge PM is located downstream (upward, +Z side) in the separation direction D2 relative to the position of the magenta cartridge PM before withdrawal of the tray unit 50 (FIG. 11B). In other words, the position of the restriction portion 302 in a case where the movable member 300 is at the first position overlaps a movement trajectory of one of the plurality of cartridges P (the black cartridge PK herein) in a case where the tray unit 50 is withdrawn from the first inside position to the first outside position.

Thus, for example, in a case where the restriction portion 302 is configured as a member fixed to the apparatus main body 1A, one of the plurality of cartridges PY to PK may interfere with the restriction portion 302 during insertion or withdrawal of the tray unit 50. In the example illustrated in FIG. 13B, the black cartridge PK may interfere with the restriction portion 302 corresponding to the magenta cartridge PM.

On the other hand, insertion and withdrawal of the tray unit 50 are performed in a state where the movable member 300 including the restriction portion 302 is retracted to the second position in the present exemplary embodiment, enabling smooth insertion and withdrawal of the tray unit 50 without the cartridge P interfering with each restriction portion 302. In other words, the configuration in which the movement direction of the tray unit 50 changes during withdrawal of the tray unit 50 from the apparatus main body 1A also enables smooth insertion and withdrawal of the tray unit 50 without the cartridge P interfering with each restriction portion 302.

Further, in the present exemplary embodiment, the orientation of the tray unit 50 at the first inside position and the orientation of the tray unit 50 at the first outside position differ. Specifically, when viewed in the Y-axis direction (third direction), the inclination angle of the tray unit 50 at the first inside position relative to horizontal is greater than the inclination angle of the tray unit 50 at the first outside position relative to horizontal. In this case, when viewed in the Y-axis direction (third direction), the inclination angle (orientation) of the tray unit 50 changes during withdrawal of the tray unit 50 from the first inside position to the first outside position, and the position of each cartridge P in the separation direction D2 also changes accordingly.

However, since insertion and withdrawal of the tray unit 50 are performed in a state where the movable member 300 is retracted to the second position in the present exemplary embodiment, even if the orientation of the tray unit 50 changes during insertion and withdrawal, each cartridge P is prevented from interfering with the restriction portion 302. In other words, the present exemplary embodiment enables smooth insertion and withdrawal of the tray unit 50, despite a configuration in which the orientation of the tray unit 50 changes during insertion and withdrawal.

Although the present exemplary embodiment describes a configuration in which each movable member 300 is retracted from the first position to the second position by the link mechanism 200 in association with the opening of the door 20, the movement direction of the movable member 300 is not limited to the foregoing direction. For example, a configuration may be employed in which the user is allowed to manually retract the movable member 300 from the first position to the second position after opening the door 20. Further, for example, a configuration may be employed in which a drive source (such as a motor or solenoid) for moving the movable member 300 is disposed and the drive source retracts the movable member 300 from the first position to the second position based on an instruction from the control unit 3.

### Support and Positioning of Movable Member

A configuration related to the support and positioning of the movable member 300 will be described with reference to FIG. 14.

FIG. 14 is a combination of an assembly view of the left side plate 120 and a holder 150 and an enlarged view of a portion of the holder 150.

As illustrated in FIG. 14, the holder 150 is attached to the left side plate 120. The holder 150 is a holding member (supporting member) configured to hold (support) the movable member 300. For example, the holder 150 is screwed to the left side plate 120 at a plurality of positions, thereby being positioned and fixed to the left side plate 120. The holder 150 constitutes a portion of the apparatus main body 1A together with the left side plate 120. In other words, the main frame 100 of the printer 1 includes the holder 150.

As described above, the left side plate 120 is formed with the opening portion 120a. The contact position of the movable member 300 is the position where the restriction portion 302 and the contact holding portion 300a, which are portions of the movable member 300, project in the +Y direction through the opening portion 120a relative to the surface of the left side plate 120 on the +Y side.

In other words, the opening portion 120a permits a portion of the movable member 300 to project toward an attachment space of the tray unit 50 relative to the left side plate 120.

The holder 150 includes a boss 150a extending in the Y-axis direction. The movable member 300 includes a boss hole 300b configured to engage with the boss 150a. The boss hole 300b is guided to the boss 150a, thereby restricting the movement direction of the movable member 300 in the Y-axis direction relative to the apparatus main body 1A including the holder 150. In other words, the movable member 300 is supported by the apparatus main body 1A in a state where movement of the cartridge P in the separation direction D2 is restricted. Desirably, the boss 150a has a length greater than or equal to the movement distance of the movable member 300 between the contact position and the separated position so that the boss 150a and the boss hole 300b remain engaged during movement of the movable member 300 from the contact position to the separated position.

Further, the holder 150 includes a boss 150b disposed at a position distant from the boss 150a when viewed in the Y-axis direction. Further, engagement of the movable member 300 with the plurality of bosses 150a and 150b restricts, for example, rotation of the movable member 300 about the boss 150a. In a case where the boss 150a is defined as a positioning portion, the boss 150b is referred to as an engagement portion for preventing rotation.

The second link 202, the third link 203, the fourth link 204, the fifth link 205, and the sixth link 206 (FIGS. 8A to 8F) constituting the link mechanism 200 are also supported by the holder 150 so that each is capable of moving as described above. In other words, the movable member 300 and at least a portion of the link mechanism 200 configured to move the movable member 300 are supported a common holder 150 in the present exemplary embodiment. This suppresses the effects of assembly tolerances on the components, thereby enabling the movable member 300 to accurately move between the contact position and the separated position. It is particularly desirable that the fifth link 205 and/or the sixth link 206 configured to be brought into direct contact with the movable member 300 and move the movable member 300 be supported by the holder 150 together with the movable member 300.

Further, the holder 150 is capable of holding an end portion (end portion on the opposite side to the end portion that is held by the contact holding portion 300a of the movable member 300) of the contact spring 301A on the −Y side.

### Example Configuration of Cartridge

An example configuration of the cartridge P will be described with reference to FIGS. 17 to 24. The cartridge P described below is an example of a cartridge P configured to be attached to the apparatus main body 1A including at least one main-body contact 301 (first contact), as in the apparatus main body 1A described above with reference to FIGS. 1 to 16. The detailed configuration of the cartridge P may be modified according to the specific configuration of the apparatus main body 1A. Thus, the configurations of the cartridge P illustrated in the FIGS. 17 to 24 do not necessarily strictly match the configurations of the cartridge P illustrated in FIGS. 1 to 16. For example, the number and arrangement of cartridge contacts of the cartridge P described below may be modified based on the number and arrangement of main-body contacts 301 (first contact) of the apparatus main body 1A.

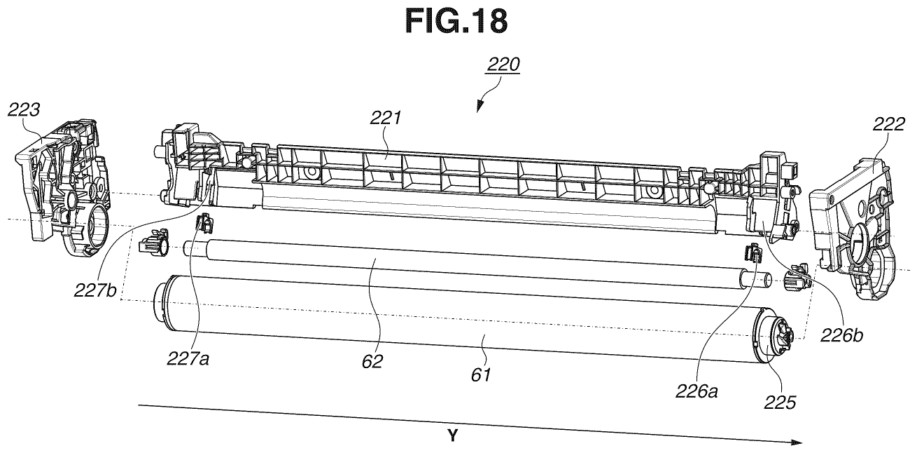

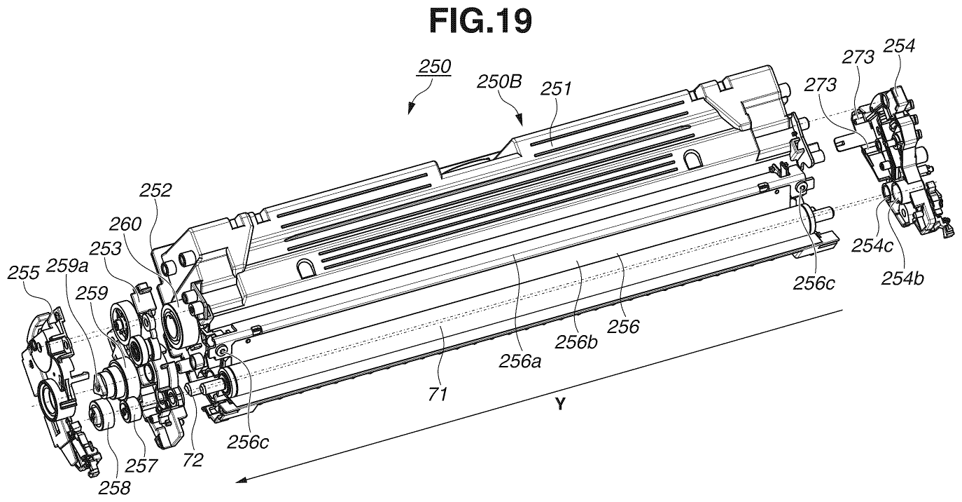

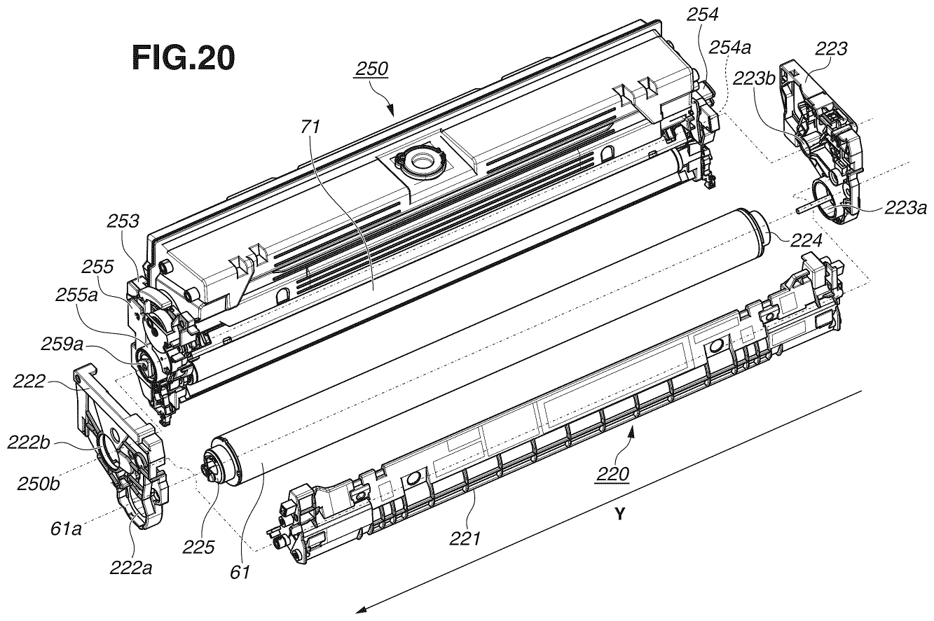

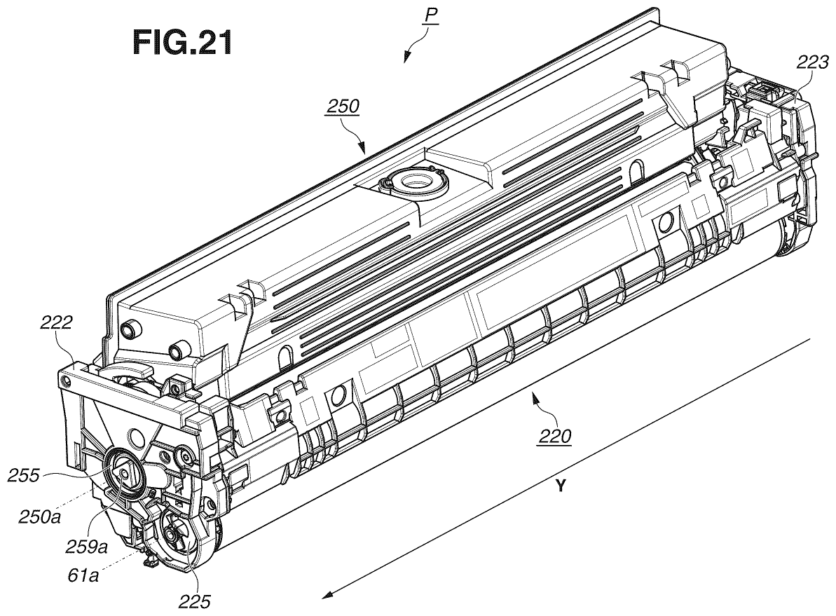

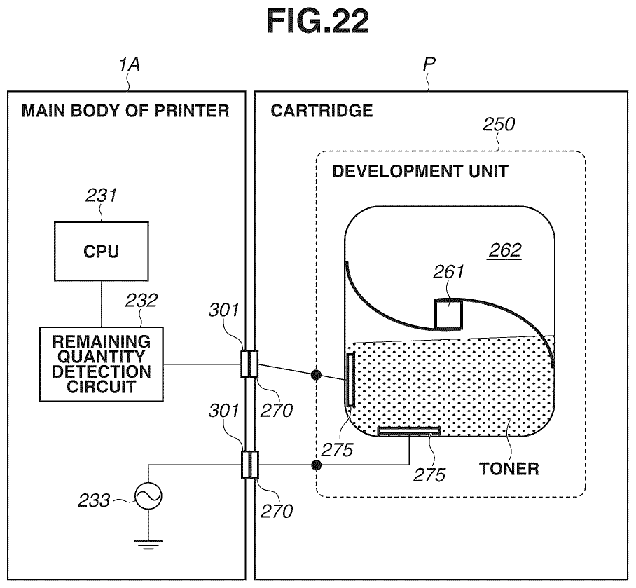

FIG. 17 is a cross-sectional view illustrating the cartridge P. FIG. 18 is an exploded perspective view illustrating a drum unit 220. FIG. 19 is an exploded perspective view illustrating a development unit 250. FIG. 20 is an assembled perspective view illustrating the cartridge P. FIG. 21 is a perspective view illustrating the cartridge P. FIG. 22 is an outline view illustrating a remaining toner quantity detection mechanism of the printer 1. FIG. 23 is a perspective view illustrating an end portion of the cartridge P on the non-drive side. FIG. 24 is a side view illustrating the cartridge P as viewed from the non-drive side.

As illustrated in FIG. 17, the cartridge P is roughly composed of the drum unit 220 and the development unit 250. The drum unit 220 includes the photosensitive drum 61 and the charging roller 62. The development unit 250 includes the development roller 71. The drum unit 220 may include a cleaning blade as a cleaning unit. The drum unit 220 and the development unit 250 are coupled to be relatively movable. A space L is formed between the drum unit 220 and the development unit 250, and light from the scanner 2 (FIG. 1) passes through the space L. The development unit 250 includes a development frame member 250B, which is a frame member of the development unit 250. An accommodating space for accommodating toner is formed inside the development frame member 250B.

The cartridge P, the drum unit 220, and the development unit 250 each have an outer shape elongated in the Y-axis direction. Thus, the Y-axis direction is referred to as a longitudinal direction for the cartridge P, the drum unit 220, and the development unit 250.

Further, the cartridge P is configured so that the drive side receives input from the apparatus main body 1A at the end portion on the +Y side. Thus, the +Y side (right side) and the −Y side (left side) may be referred to as the drive side and the non-drive side, respectively.

### Drum Unit

As illustrated in FIGS. 18 and 20, the drum unit 220 includes the photosensitive drum 61, the charging roller 62, a drum frame member 221, bearings 226a and 227a, pressing springs 226b and 227b, a drive-side cover 222, and the non-drive side cover 223.

An end portion of the photosensitive drum 61 on the drive side is engaged with a drum support hole 222a of the drive-side cover 222, and an end portion of the photosensitive drum 61 on the non-drive side is engaged with a drum support hole 223a of the non-drive side cover 223 (FIG. 20). The photosensitive drum 61 is supported by the drive-side cover 222 and the non-drive side cover 223 so that the photosensitive drum 61 is rotatable about a rotational axis 61a.

A drum coupling 225 is formed at the end portion of the photosensitive drum 61 on the drive side. The drum coupling 225 is an input member to which a driving force of a motor disposed in the apparatus main body 1A is input. The apparatus main body 1A is provided with four main-body couplings as output members configured to output the driving force of the motor. Each main-body coupling is disposed to engage with the drum coupling 225 of each cartridge P in a state where the cartridges PY to PK are positioned at the image forming positions. The driving force is transmitted via the main-body couplings and the drum coupling 225 to drive and rotate the photosensitive drum 61 in a predetermined direction (direction of an arrow A in FIG. 17).

The charging roller 62 is rotatably supported by the bearings 226a and 227a supported by the drum frame member 221. Further, the bearings 226a and 227a are pressed against the pressing springs 226b and 227b, thereby urging the charging roller 62 toward the photosensitive drum 61 (in the direction of an arrow F in FIG. 17). The charging roller 62 rotates following the photosensitive drum 61 (in the direction of an arrow E in FIG. 17). In the Y-axis direction, the end portion of the drum frame member 221 on the drive side is connected to the drive-side cover 222, and the end portion of the drum frame member 221 on the non-drive side is connected to the non-drive side cover 223.

### Development Unit

As illustrated in FIGS. 17 and 19, the development unit 250 includes the development frame member 250B, the development roller 71, a supply roller 72, a development blade 256, an agitation member 261, and a drive train (257, 258, 259).

The development frame member 250B includes a first frame 251, a second frame 252, a drive-side bearing 253, a non-drive side bearing 254, and a drive-side cover 255. The first frame 251 and the second frame 252 form a toner storage portion 262 (FIG. 17) as an accommodating space for accommodating toner. An edge portion of the first frame 251 and an edge portion of the second frame 252 are joined using, for example, ultrasonic welding or hot-melt adhesive.

The first frame 251 and the second frame 252 are frame members configured to form a container (development container) in which the toner storage portion 262 is formed. The drive-side bearing 253 is attached to one end side (drive side) of the development container in the Y-axis direction, and the non-drive side bearing 254 is attached to another end side (non-drive side) of the development container in the Y-axis direction. The drive-side bearing 253 and the non-drive side bearing 254 are fixed to the first frame 251 and the second frame 252, for example, using a screw fastening method.

The drive-side cover 255 is disposed further outside the drive-side bearing 253 (further toward the drive side) in the Y-axis direction. The drive-side cover 255 is fixed (fastened) together with the drive-side bearing 253 to the first frame 251 and the second frame 252, for example, using a screw fastening method.

In the present exemplary embodiment, the development frame member 250B as a frame member of the development unit 250 is formed as an integrated structure of the first frame 251, the second frame 252, the drive-side bearing 253, the non-drive side bearing 254, and the drive-side cover 255.

Both end portions of the development roller 71 in the Y-axis direction are rotatably supported by the drive-side bearing 253 and the non-drive side bearing 254 as bearing members. Further, the end portions of the supply roller 72 in the Y-axis direction are rotatably supported by the drive-side bearing 253 and the non-drive side bearing 254.

The development blade 256 includes an elastic member 256b as a main body of the development blade 256 and a supporting member 256a configured to support the elastic member 256b. The elastic member 256b is, for example, a sheet metal having a thickness of approximately 0.1 mm. The supporting member 256a is, for example, a high-rigidity metal member having an L-shaped cross section. The elastic member 256b is fixed to the supporting member 256a using a welding method. Further, both end portions of the supporting member 256a in the Y-axis direction are fixed to the development frame member 250B (the first frame 251), for example, using screws 256c.

The agitation member 261 includes a rotation shaft 261a and agitation sheets 261b and 261c. The rotation shaft 261a extends approximately parallel to the rotational axis of the development roller 71, and the agitation sheets 261b and 261c are formed of flexible sheet materials. The agitation sheets 261b and 261c each have one end (fixed end) attached to the rotation shaft 261a, and other ends of the agitation sheets 261b and 261c are free ends. The agitation member 261 is configured to agitate the toner stored in the toner storage portion 262 by causing the agitation sheets 261b and 261c to rotate about the rotation shaft 261a following the rotation of the rotation shaft 261a. Further, with rotation of the rotation shaft 261a, the agitation sheets 261b and 261c, functioning as toner conveyance portions, convey toner to the development roller 71 and the supply roller 72.

A drive transmission configuration of the development unit 250 will be described. The drive train described above includes an input gear 259, a development roller gear 257, a supply roller gear 258, and an agitation gear 260 and is disposed at an end portion of the development unit 250 on the drive side (FIG. 19). At least a portion of the drive train is accommodated in a space formed between the drive-side bearing 253 and the drive-side cover 255.

The development roller gear 257, the supply roller gear 258, and the agitation gear 260 are connected to the input gear 259 either directly or indirectly and configured to rotate in association with rotation of the input gear 259. The development roller gear 257 is provided at an end portion of the development roller 71 on the drive side. The supply roller gear 258 is provided at an end portion of the supply roller 72 on the drive side. The agitation gear 260 is provided at an end portion of the agitation member 261 on the drive side.

The input gear 259 includes a development coupling 259a. The input gear 259 functions as an input member to which the driving force of the motor disposed in the apparatus main body 1A is input. The apparatus main body 1A is provided with four main-body couplings for development as output members configured to output the driving force of the motor. Each main-body coupling for development is disposed to engage with the development coupling 259a of each process cartridge in a state where the cartridges PY to 100K are positioned at the image forming positions. The driving force is transmitted via the main-body couplings for development and the development coupling 259a to drive and rotate the development roller 71, the supply roller 72, and the agitation member 261 in predetermined directions (the directions of arrows C, D, and G in FIG. 17).

### Cartridge Assembly Method

An assembly method of the cartridge P will be described with reference to FIGS. 20 and 21. As illustrated in FIG. 21, the drive-side cover 222 and the non-drive side cover 223 are provided with development unit support holes 222b and 223b for supporting the development unit 250 so that the development unit 250 can swing (move). On the other hand, the drive-side cover 255 of the development unit 250 is provided with a cylindrical portion 255a configured to engage with the development unit support hole 222b. The non-drive side bearing 254 of the development unit 250 is provided with a cylindrical portion 254a configured to engage with the development unit support hole 223b.

In other words, the development frame member 250B of the development unit 250 is provided with the cylindrical portions 254a and 255a as engagement portions.

During assembly of the cartridge P, the cylindrical portions 254a and 255a of the development frame member 250B are engaged with the development unit support holes 222b and 223b of the drive-side cover 222 and the non-drive side cover 223. At the same time, both end portions of the photosensitive drum 61 are engaged with the drum support holes 222a and 223a of the drive-side cover 222 and the non-drive side cover 223. Then, the drive-side cover 222 and the non-drive side cover 223 are fixed to the drum frame member 221 using a screw or adhesive.

Consequently, the cartridge P is assembled so that the development unit 250 can swing relative to the drum unit 220 (FIG. 21). The development unit 250 swings about an axial line 250a relative to the drum unit 220, permitting the development roller 71 to move closer to and away from the photosensitive drum 61. For example, during image formation, the development roller 71 is held at a position in contact with the photosensitive drum 61 or at a position facing the photosensitive drum 61 with a predetermined gap therebetween, whereas during non-image formation (a period during which the image forming operation is not performed), the development roller 71 is held at a position separated from the photosensitive drum 61.

The axial line 250a of the development unit 250 is an imaginary straight line connecting the center of the development unit support hole 222b of the drive-side cover 222 and the center of the development unit support hole 223b of the non-drive side cover 223. The axial line 250a is substantially the same as the rotational axis of the development coupling 259a of the development unit 250. In other words, the development unit 250 receives the driving force transmitted from the apparatus main body 1A via the input member disposed coaxially with the axial line 250a of the development unit 250.

The drum unit 220 including the drive-side cover 222 and the non-drive side cover 223 is described as being coupled to the development unit 250. It is also possible to consider that a drum unit including the photosensitive drum 61, the charging roller 62, and the drum frame member 221 and a development unit are coupled by the drive-side cover 222 and the non-drive side cover 223, which serve as cover members of the entire process cartridge.

### Power Supply Path for Electrical Component

Next, a configuration of a power supply path for electrical components of the cartridge P will be described. The electrical components refer to components that function when electrically connected to an electric circuit of the apparatus main body 1A.

The electrical components in the present exemplary embodiment include the development roller 71, the development blade 256, and electrode sheets 275 (FIG. 17). The cartridge P may be configured without some of the electrical components or may include an additional electrical component.

As illustrated in FIGS. 23 and 24, the cartridge P includes at least one cartridge-side contact 270 connected to the main-body contact 301. Each cartridge-side contact 270 is a member (second contact) configured to be brought into contact with the main-body contact 301 (first contact) to electrically connect the cartridge P and the apparatus main body 1A. In the present exemplary embodiment, the cartridge P includes, as the plurality of cartridge-side contacts 270, a first contact 270a, a second contact 270b, a third contact 270c, a fourth contact 270d, and a fifth contact 270e.

Each cartridge-side contact 270 is disposed at the end portion of the cartridge P on the non-drive side. More specifically, the first contact 270a is disposed at an end surface of the drum frame member 221 (FIG. 18) on the non-drive side (−Y side). The second contact 270b, the third contact 270c, the fourth contact 270d, and the fifth contact 270e are disposed at an end surface of the non-drive side bearing 254 (FIG. 19) of the development unit 250 on the non-drive side (−Y side).

The non-drive side cover 223 of the cartridge P is formed with opening windows 223c, 223d, and 223e (FIG. 23), which are opening portions penetrating the non-drive side cover 223 in the Y-axis direction. When the cartridge P is viewed from the non-drive side in the Y-axis direction, at least a portion of the first contact 270a is exposed through the opening window 223c, and at least a portion of the second contact 270b and at least a portion of the third contact 270c are exposed through the opening window 223d (FIG. 24). Further, when the cartridge P is viewed from the non-drive side in the Y-axis direction, at least a portion of the fourth contact 270d and at least a portion of the fifth contact 270e are exposed through the opening window 223e.

Each contact (270a to 270e) may be composed solely of a conductive resin constituting a portion of the drum frame member 221 or a portion of the non-drive side bearing 254, or may be a conductive member such as metal fixed to the drum frame member 221 or the non-drive side bearing 254.

The first contact 270a is electrically connected to one of the electrode sheets 275 (FIG. 17) and may be brought into contact with one of the main-body contacts 301 (first main-body contact) in a state where the cartridge P is attached to the apparatus main body 1A. The second contact 270b is electrically connected to another one of the electrode sheets 275 and may be brought into contact with another one of the main-body contacts 301 (second main-body contact) of the apparatus main body 1A in a state where the cartridge P is attached to the apparatus main body 1A. The third contact 270c is electrically connected to the development roller 71 and may be brought into contact with another one of the main-body contacts 301 (third main-body contact) in a state where the cartridge P is attached to the apparatus main body 1A. The fourth contact 270d is electrically connected to the development blade 256 and may be brought into contact with another one of the main-body contacts 301 (fourth main-body contact) in a state where the cartridge P is attached to the apparatus main body 1A. The fifth contact 270e is electrically connected to the charging roller 62 and may be brought into contact with another one of the main-body contacts 301 (fifth main-body contact) in a state where the cartridge P is attached to the apparatus main body 1A.

The first contact 270a and the second contact 270b constitute a portion of a remaining toner quantity detection mechanism described below. The development roller 71 is electrically connected to a high-voltage board of the apparatus main body 1A via the third contact 270c and the main-body contact 301 (third main-body contact), and a development voltage is applied from the high-voltage board to the development roller 71.

The development blade 256 is electrically connected to the high-voltage board of the apparatus main body 1A via the fourth contact 270d and the main-body contact 301 (fourth main-body contact), and a bias voltage (blade voltage) for increasing the toner charge amount is applied from the high-voltage board to the development blade 256. The charging roller 62 is electrically connected to the high-voltage board of the apparatus main body 1A via the fifth contact 270e and the main-body contact 301 (fifth main-body contact), and a charging voltage is applied from the high-voltage board to the charging roller 62.

### Remaining Toner Quantity Detection Mechanism

The printer 1 includes a remaining toner quantity detection mechanism configured to detect the quantity (hereinafter, referred to as “remaining toner quantity”) of toner stored in the development unit 250 (in the cartridge P). FIG. 22 is a schematic view illustrating an example of the remaining toner quantity detection mechanism.

The remaining toner quantity detection mechanism includes a central processing unit (CPU) 231, a remaining quantity detection circuit 232, a voltage application unit 233, and two main-body contacts 301 disposed in the apparatus main body 1A. Further, the remaining toner quantity detection mechanism includes the first contact 270a, the second contact 270b, and two electrode sheets 275 disposed in the cartridge P.

One of the electrode sheets 275 is electrically connected to the voltage application unit 233 of the apparatus main body 1A via the first contact 270a and the main-body contacts 301 (first main-body contact). The other one of the electrode sheets 275 is electrically connected to the remaining quantity detection circuit 232 of the apparatus main body 1A via the second contact 270b and the main-body contacts 301 (second main-body contact). The CPU 231 is electrically connected to the remaining quantity detection circuit 232. The CPU 231 and the remaining quantity detection circuit 232 may be part of a control unit (control board) installed in the apparatus main body 1A.

Each electrode sheet 275 is exposed to the toner storage portion 262 in the development frame member 250B. Hereinafter, the electrode sheet 275 to which a voltage applied from the voltage application unit 233 will be referred to as the input-side electrode sheet 275, and the electrode sheet 275 that is electrically connected to the remaining quantity detection circuit 232 will be referred to as the output-side electrode sheet 275.

The remaining toner quantity detection mechanism according to the present exemplary embodiment is a capacitive detection mechanism configured to detect the remaining toner quantity based on the result of detecting the capacitance between the two electrode sheets 275. The CPU 231 causes the voltage application unit 233 to apply an alternating-current voltage to the input-side electrode sheet 275 (first electrode), thereby inducing capacitance between the electrode sheets 275. The magnitude of the capacitance between the electrode sheets 275 varies with the amount of dielectric material, i.e., toner, present between the electrode sheets 275.

The remaining quantity detection circuit 232 outputs a detection signal corresponding to the capacitance between the electrode sheets 275.

As a specific example, the remaining quantity detection circuit 232 acquires a reference voltage by applying the same alternating-current voltage as that applied to the input-side electrode sheet 275 to a reference capacitive element with a known capacitance. Further, the remaining quantity detection circuit 232 compares the voltage value of the output-side electrode sheet 275 (second electrode) with the reference voltage and outputs a voltage value as a detection signal as the difference between the compared voltages.

The CPU 231 performs control based on the remaining toner quantity based on the detection signal from the remaining quantity detection circuit 232. For example, in a case where the remaining toner quantity falls below a preset threshold, the CPU 231 notifies the user of information (cartridge replacement information) to prompt the user to replace the cartridge P. The notification method may be a screen display on an operation panel of the printer 1 or a notification transmitted to an external information processing terminal connected to the printer 1 to communicate with the printer 1.

The remaining toner quantity detection mechanism described above is merely an example of the remaining quantity detection mechanism configured to detect the quantity of developer stored in a storage portion (the toner storage portion 262) in the cartridge P. The remaining quantity detection mechanism is not limited to the capacitance method described in the present exemplary embodiment and may employ, for example, an optical detection method. In the optical detection method, light emitted from a light-emitting element passes through a space inside the toner storage portion 262 and enters a light-receiving element, and the remaining toner quantity is detected based on a detection signal from the light-receiving element utilizing changes in the duration of light obstruction corresponding to the remaining toner quantity.

### Shape of End Portion of Cartridge

The shape of the end portion of the cartridge P on the −Y side (non-drive side, left side) and the positions of the cartridge-side contacts 270 will be described with reference to FIGS. 23 and 24.

As illustrated in FIGS. 23 and 24, at least a portion of the end surface of the cartridge P on the −Y side is formed by the non-drive side cover 223 in the present exemplary embodiment. The non-drive side cover 223 includes a side surface portion 223s and the rib structure 223r. The side surface portion 223s is a surface facing the −Y side, and the rib structure 223r projects toward the −Y side relative to the side surface portion 223s. In a case where the side surface portion 223s is defined as a first surface, an end surface (a surface forming a ridge line) of the rib structure 223r on the −Y side is referred to as a second surface projecting toward the −Y side from the first surface.

At least a portion of the side surface portion 223s is a surface extending in a direction intersecting the Y-axis direction (desirably a direction substantially orthogonal to the Y-axis direction). The opening windows 223c, 223d, and 223e through which the cartridge-side contacts 270 are exposed are formed mainly in the side surface portion 223s. However, an opening edge of the opening window 223d on the upper side (+Z side) is formed by the rib structure 223r.

When viewed in the Y-axis direction, the side surface portion 223s has a larger area than the rib structure 223r. In the present exemplary embodiment, “the side surface portion 223s” refers to the end surface of the non-drive side cover 223 on the −Y side excluding the rib structure 223r and the opening windows 223c, 223d, and 223e.

In the present exemplary embodiment, the rib structure 223r is formed at an upper portion of the side surface portion 223s and extends approximately along the X-axis direction. In other words, the rib structure 223r extends along the movement direction of the tray unit 50. The rib structure 223r may be disposed at an end portion of the non-drive side cover 223 on the upper side (+Z side).

The provision of the rib structure 223r enhances the strength (rigidity) of the non-drive side cover 223.

A storage medium 223m (memory tag) configured to store information about the cartridge P may be attached to the end surface 223u of the non-drive side cover 223 on the upper side (+Z side) (FIG. 23, FIG. 24). The apparatus main body 1A includes a tag connector configured to be brought into contact with a contact exposed from an upper surface of the storage medium 223m in a state where the tray unit 50 is inserted in the apparatus main body 1A. Electrically connecting a tag connector of the apparatus main body 1A to a contact of the storage medium 223m enables the control unit 3 of the printer 1 to read information from the storage medium 223m. Examples of information stored in the storage medium 223m include identification information (production lot) about the cartridge P, toner color, or toner level.

The storage medium 223m is disposed on the non-drive side cover 223 forming the end surface of the cartridge P on the −Y side, thereby disposing the tag connector of the apparatus main body 1A near the left side plate 120. This enables a reduction in the length of a harness connecting the tag connector to the control unit 3, compared to a configuration in which, for example, the storage medium 223m is disposed closer to the +Y side (closer to the center of the cartridge P) than the non-drive side cover 223 is.

As illustrated in FIG. 11, the contact positions where the main-body contacts 301 are in contact with the cartridge-side contacts 270 may be closer to the +Y side (cartridge P side) than an end portion position 223m1 of the storage medium 223m on the −Y side (left side plate 120 side) is.

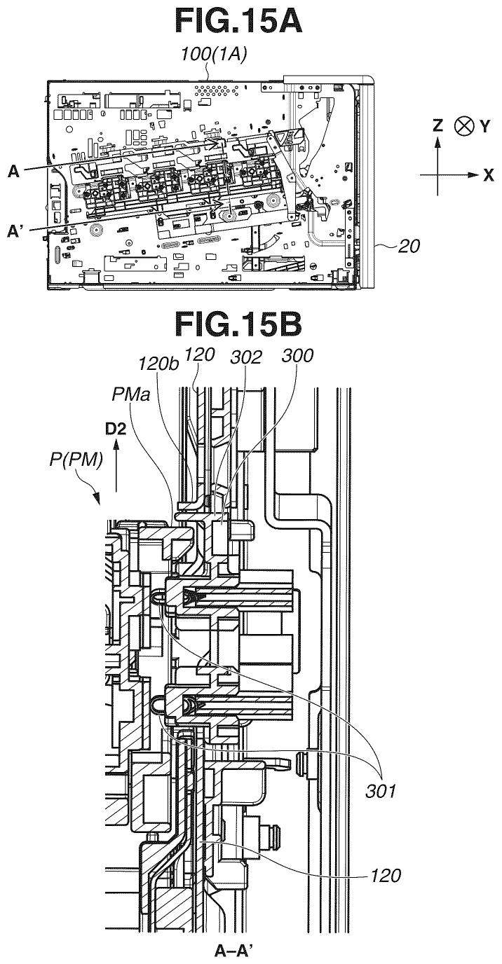

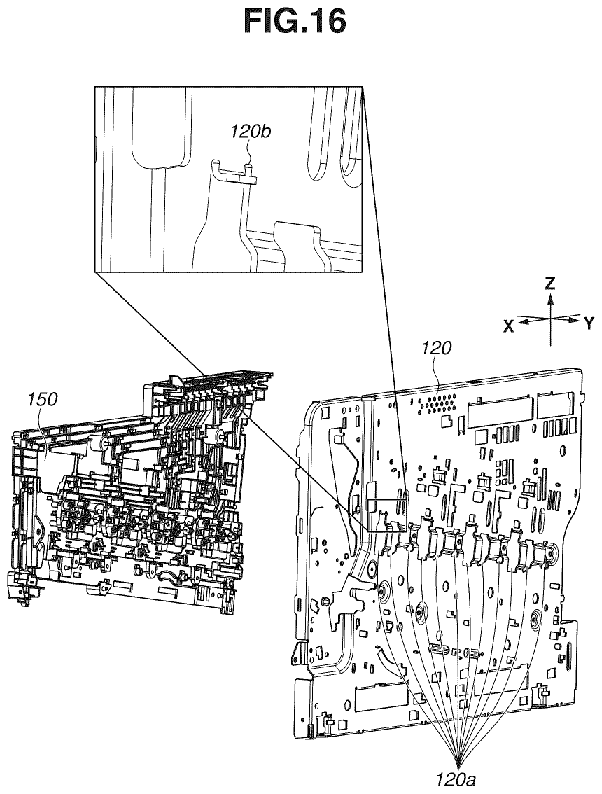

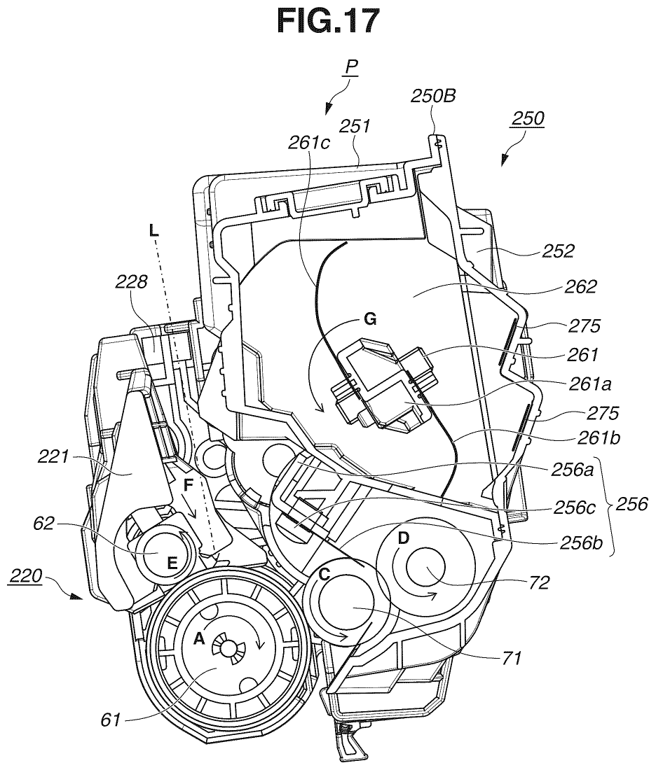

An image forming apparatus according to a second exemplary embodiment will be described with reference to FIGS. 15A, 15B, and 16. The present exemplary embodiment differs from the first exemplary embodiment in that the left side plate 120 includes a supporting portion 120b configured to support the movable member 300.

Hereinafter, components assigned the same reference numeral as in the first exemplary embodiment are assumed to have basically the same configuration and function as those in the first exemplary embodiment, unless otherwise specified, and the following description primarily focus on the differences from the first exemplary embodiment.

FIG. 15A is an outline view illustrating the printer 1 in a state where the door 20 is at the closed position and the tray unit 50 is inserted at the first inside position of the apparatus main body 1A. FIG. 15B is a cross-sectional view along line A-A′ in FIG. 15A. FIG. 16 is a combination of a perspective view illustrating the left side plate 120 and the holder 150 and an enlarged view of a portion of the left side plate 120.

As illustrated in FIGS. 15B and 16, the left side plate 120 according to the present exemplary embodiment includes the supporting portion 120b. The supporting portion 120b is disposed at an edge portion of the opening portion 120a in the separation direction D2 where the restriction portion 302 of the movable member 300 is disposed. The supporting portion 120b has a bent shape formed by bending a portion of the sheet metal of the left side plate 120, which is a sheet metal member, toward the +Y side. In other words, the supporting portion 120b in the present exemplary embodiment is integrally formed with the other portion of the left side plate 120.

As illustrated in FIGS. 15A and 15B, in a state where the door 20 is at the closed position and the tray unit 50 is inserted at the first inside position of the apparatus main body 1A, the movable member 300 is at the first position as in the first exemplary embodiment. Thus, the restricted surface PMa of the cartridge P is restricted by the restriction portion 302 of the movable member 300, and the cartridge P is prevented from moving from the tray 51 toward the separation direction D2 due to an impact from a fall.

In a state where the movable member 300 is at the first position, the supporting portion 120b of the left side plate 120 faces the restriction portion 302 in the separation direction D2. The supporting portion 120b is brought into contact with the restriction portion 302, thereby functioning as a receiving portion configured to receive pressing force in the separation direction D2 that is received by the restriction portion 302 in a case where the restriction portion 302 is pressed by the cartridge P. The restriction portion 302 is supported (backed up) by the supporting portion 120b from the downstream side in the separation direction D2, thereby restricting misregistration or deformation of the movable member 300, such as displacement of the restriction portion 302 in the separation direction.

In the present exemplary embodiment, while the movable member 300 is made of synthetic resin, the supporting portion 120b is a portion of the left side plate 120 formed from sheet metal, and the strength of the supporting portion 120b is higher than that of the movable member 300. In other words, in the present exemplary embodiment, a force that moves the cartridge P in the separation direction D2 due to the impact of a fall is received by the high-strength supporting portion 120b instead of the restriction portion 302 made of resin. This ensures that movement (misregistration) of the cartridge P in the separation direction D2 (second direction) is restricted.

Further, since the supporting portion 120b formed by bending the sheet metal extends along the movement direction of the movable member 300, the supporting portion 120b can guide the movement of the restriction portion 302. In other words, burrs on the restriction portion 302 do not catch on the edge of the opening portion 120a during movement of the movable member 300 between the first position and the second position in the Y-axis direction (third direction), enabling smoother operation.

The present disclosure makes it possible to provide an image forming apparatus capable of restricting cartridge misregistration without affecting the operability of a tray.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-111320, filed Jul. 10, 2024, which is hereby incorporated by reference herein in its entirety.

What is claimed is:

1. An image forming apparatus comprising:
a housing;
a tray inserted in the housing, the tray being configured to be withdrawn toward a first direction from a state where the tray is inserted in the housing;
a cartridge attached to the tray, the cartridge being configured to be separated from the tray in a second direction intersecting the first direction in a state where the tray is withdrawn from the housing; and
a movable member supported by the housing and including a restriction portion, the movable member being configured to be restricted from moving in the second direction and being configured to move between a first position and a second position in a third direction intersecting both the first direction and the second direction,
wherein, in a state where the tray is inserted in the housing and the movable member is at the first position, the restriction portion overlaps the cartridge when viewed in the second direction, and the restriction portion restricts movement of the cartridge in the second direction relative to the tray, whereas in a state where the tray is inserted in the housing and the movable member is at the second position, the restriction portion does not overlap the cartridge when viewed in the second direction, and
wherein, in a case where the movable member is at the second position, the restriction portion is retracted from a movement trajectory of the tray and the cartridge, where the movement trajectory of the tray and the cartridge is a space through which the tray and the cartridge pass during withdrawal of the cartridge and the tray from the housing.

2. The image forming apparatus according to claim 1, wherein the housing is formed with an opening configured to permit insertion and withdrawal of the tray,
the image forming apparatus further comprising:
an opening and closing member, the opening and closing member being configured to move relative to the housing between a closed position where the opening is covered and an opened position where the opening is exposed,
wherein the movable member is configured to move from the first position to the second position in association with the movement of the opening and closing member from the closed position to the opened position, and is configured to move from the second position to the first position in association with the movement of the opening and closing member from the opened position to the closed position.

3. The image forming apparatus according to claim 2, wherein the opening is formed in a side surface portion of the housing on a downstream side in the first direction.

4. The image forming apparatus according to claim 1, further comprising a first contact disposed in the housing,
wherein the cartridge includes a second contact, and
wherein the cartridge is electrically connected to the housing by bringing the second contact and the first contact into contact with each other, and
wherein the movable member is configured to move the first contact between a contact position where the first contact is in contact with the second contact and a separated position where the first contact is separated from the second contact.

5. The image forming apparatus according to claim 4, further comprising an elastic member disposed in the housing and configured to elastically deform in the third direction,
wherein the first contact is provided at an end portion of the elastic member, and
wherein, in a case where the movable member moves from the first position to the second position, the movable member moves the first contact from the contact position to the separated position against a restorative force of the elastic member, whereas
in a case where the movable member moves from the second position to the first position, the movable member permits the first contact to move from the separated position to the contact position in accordance with the restorative force of the elastic member.

6. The image forming apparatus according to claim 1, wherein, in a state where the tray is inserted in the housing and the movable member is at the first position, the restriction portion faces an end surface of the cartridge in the second direction, and a gap is present between the restriction portion and the end surface.

7. The image forming apparatus according to claim 1, further comprising a plurality of cartridges including the cartridge, each of the plurality of cartridges being configured to be attached to and detached from the tray,
wherein the tray is configured to move between an inside position where the tray is positioned when an image forming operation is performed using the plurality of cartridges and an outside position where the tray is withdrawn from the housing to permit the plurality of cartridges to be separated from the tray.

8. The image forming apparatus according to claim 7, further comprising a plurality of movable members including the movable member, the plurality of movable members being disposed to correspond respectively to the plurality of cartridges and being configured to restrict movement of the corresponding cartridge in the second direction,
wherein the plurality of movable members is disposed in alignment along the first direction.

9. The image forming apparatus according to claim 7, wherein a position of the restriction portion in a case where the movable member is at the second position is retracted from a movement trajectory of the plurality of cartridges, where the movement trajectory of the plurality of cartridges is a space through which the plurality of cartridges passes during withdrawal of the plurality of cartridges and the tray from the housing.

10. The image forming apparatus according to claim 7, wherein a position of the restriction portion in a case where the movable member is at the first position overlaps a movement trajectory of at least one of the plurality of cartridges, where the movement trajectory of the at least one of the plurality of cartridges is a space through which the at least one of the plurality of cartridges passes during withdrawal of the plurality of cartridges and the tray from the housing.

11. The image forming apparatus according to claim 7, wherein, when viewed in the third direction, the tray is moved in the first direction from the inside position to a predetermined position between the inside position and the outside position, and the tray is moved in a fourth direction from the predetermined position to the outside position, the fourth direction having a different inclination angle relative to a horizontal direction from an inclination angle of the first direction.

12. The image forming apparatus according to claim 11, wherein in a case where the tray is positioned at the predetermined position, a first cartridge is located downstream of a first movable member and upstream of a second movable member in the first direction, where the first cartridge is a cartridge that is located at the most upstream position in the first direction among the plurality of cartridges, a second cartridge is a cartridge that is located at the most downstream position in the first direction among the plurality of cartridges, the first movable member is a movable member that corresponds to the first cartridge among the plurality of movable members, and the second movable member is a movable member that corresponds to the second cartridge among the plurality of movable members.

13. The image forming apparatus according to claim 7, wherein, when viewed in the third direction, an inclination angle of the tray relative to a horizontal direction in a case where the tray is at the inside position differs from the inclination angle of the tray relative to the horizontal direction in a case where the tray is at the outside position.

14. The image forming apparatus according to claim 1,
wherein the housing includes a first side plate disposed on one side in the third direction relative to an accommodating space configured to accommodate the tray inserted in the housing, and includes a second side plate disposed on another side in the third direction relative to the accommodating space, and
wherein the restriction portion restricts movement of the cartridge in the second direction by being brought into contact with an end portion of the cartridge on the one side in the third direction.

15. The image forming apparatus according to claim 14,
wherein the first side plate is formed with an opening portion, and
wherein, in a state where the movable member is at the first position, the restriction portion projects toward the accommodating space relative to the first side plate through the opening portion.

16. The image forming apparatus according to claim 1,
wherein the first side plate is made of metal,
wherein the movable member is made of resin, and
wherein the first side plate includes a receiving portion configured to face an end surface of the movable member in the second direction in a state where the movable member is at the first position, and configured to restrict movement of the movable member in the second direction in a case where the cartridge presses the restriction portion in the second direction.
